(19) United States
(12) Patent Application Publication
(10) Pub. No.: US 2004/0096586 A1
(43) Pub. Date: May 20, 2004

(54) System for deposition of mesoporous materials

(76) Inventors: Michelle T. Schulberg, Palo Alto, CA (US); Raashina Humayun, San Jose, CA (US); Patrick A. Van Cleemput, Sunnyvale, CA (US); Wilbert G.M. Van den Hoek, Saratoga, CA (US)

Correspondence Address: LATHROP & GAGE LC, 4845 PEARL EAST CIRCLE, SUITE 300, BOULDER, CO, 80301, US

(21) Appl. No.: 10/295,965

(22) Filed: Nov. 15, 2002

(51) Int. Cl. B05D 3/02

(52) U.S. Cl. 427/372.2; 427/457; 118/715

(57) ABSTRACT

An automated deposition system includes a template deposition chamber that is used to deposit a mesostructured template on a wafer or other substrate, such as an optical lens. A supercritical infusion chamber infuses the mesoporous template with a matrix-forming material that is cured to produce a mesoporous matrix. The template may be removed by thermal, chemical or plasma processing to leave the mesoporous matrix intact.

### BACKGROUND OF THE INVENTION

1. Field of the Invention

The invention pertains to the field of mesoporous materials and methods of making the same. More specifically, a system is configured for sequential processing of substrates, such as wafers, to deposit or form mesostructured materials on the substrates.

2. Discussion of the Related Art

Mesoporous inorganic materials are supported films that may exhibit highly ordered microstructures and porosity. The microstructure and porosity derive from an ordered micelle or liquid-crystalline precursor solution. The precursor solution is, in principle, a multiphase emulsion that contains a solvent or solvents, a template phase, and a matrix phase. As the precursor is cured or dried, the template phase congeals into a mesoscale structure and the matrix phase solidifies around the template phase. The template phase may later be removed to leave only the solidified mesoporous matrix. Uses for mesoporous films include sensors, membranes, low dielectric constant interlayers, anti-reflective coatings, and optical hosts.

The International Union of Pure and Allied Chemistry (IUPAC) defines mesoporous materials as those having an average pore diameter, dᵢₚ, in the range 2 nm<dᵢₚ<50 nm; however, the chemical literature may include other range definitions, most commonly 0.8 nm<dᵢₚ<20 nm.

U.S. Pat. No. 5,858,457 issued to Brinker et al. describes advances in mesoporous molecular sieves including supramolecular templating processes, synthesis procedures, extending the compositional range beyond silicas, and the processing of mesoporous molecular sieves as thin films. The process chemistry uses four reagents including water, surfactant, a soluble inorganic precursor, and a catalyst. These materials are all combined into a single solution that must be carefully prepared, for example, to establish a surfactant concentration within a critical micelle range. Tetraethyl orthosilicate (TEOS)-based silica sol-gels are used to make the mesoporous materials and include a mixture of TEOS, ethanol, water, hydrochloric acid, and CH₃(CH₂)₁₅N(CH₃)₃Br (CTAB; a cationic surfactant), respectively, in mole ratios from 1:22:5:0.004:0.093 to 0.31 all below a critical micelle concentration as confirmed by spectroscopic studies. The silica sol-gels are applied to silica wafers by spin-on and dip-coating procedures and calcined to yield mesoporous silicates. Prior to removal of surfactant materials, pure silica mesostructured materials that are formed by this methodology have structure types including:

(1) hexagonal, which is sometimes referred to as H or MCM-4, a 1-d system of hexagonally ordered cylindrical silica channels encasing cylindrical surfactant micellar assemblies;

(2) cubic, a 3-d, bicontinuous system of silica and surfactant; and

(3) lamellar, a 2-d system of silica sheets interleaved by surfactant bilayers.

A single solution using anionic cubic octamers Si₈O₂₀⁸⁻ has demonstrated reversible lamellar to hexagonal phase transformations. The template may be removed by pyrolysis, which frequently results in retention of the hexagonal and cubic structure types, while the lamellar phase frequently collapses and/or becomes amorphous. In crystal form, the structure types or crystalline phases are often referred to as spherical, cylindrical, or lamellar types.

The '457 patent underscores the difficulties of producing mesoporous materials from a single solution, both by experimental results and by admitting that there is no theory to fully explain the templating process. Specific details concerning co-assembly of silicates and the template during the templating process are still controversial, but generally pertain to a silicate-solvent interaction. Competing theories and/or models used to explain this phenomenon include a puckering layered model, silicate rod assembly, and cooperative charge density matching. Calcined films demonstrated progressive structural changes paralleling the hexagonal, cubic and lamellar phases as a function of the solvent concentration. The lamellar phase tends to collapse upon calcination, e.g., at 400° C., especially at film surface boundaries. The film quality varies as a function of sol-gel aging time, which should be neither too long nor too short. Proceeding depthwise through the mesoporous film, structural changes may be observed at a drying line as the solvent evaporates, and the drying rates may affect the ultimate structure. Thus, the processes are poorly suited to semiconductor manufacturing because they have poor repeatability and produce layers of mesoporous materials having inconsistent depthwise quality.

U.S. Pat. No. 5,922,299 issued to Bruinsma et al. describes the production of mesoporous materials through use of TEOS sol-gels. The silica sol-gels are thinned and dried prior to calcination. This thinning and drying accelerates the time required to obtain mesoporous materials. The TEOS sol-gels include a mixture of TEOS, ethanol, water, hydrochloric acid, and cetyltrimethylammonium chloride (CTAC), respectively, in mole ratios of 1:5.7:7.2:0.1:0 to 0.3. All of the ingredients are combined in a single sol-gel for deposition. The '299 patent confirms that significant variations in mesoporosity may be obtained by varying the solution concentrations and the process conditions. These results may not be repeatable, for example, due to process temperatures or sol-gel aging times.

Sol-gels may be supplemented with polymers to produce composite nanophases, as described in U.S. Pat. No. 6,264,741 to Brinker et al. Based upon the solvent evaporation process, it may be possible to form layered mesophases, tubular mesophases, and a hierarchical composite coating that includes an isotropic worm-like micellar overlayer bonded to an oriented, nanolaminated underlayer. TEOS sol-gels may be supplemented with photoinitiated or thermally initiated polymers, for example, in mole ratios of 1 TEOS:22.5 ethanol:5 water:0.004 hydrochloric acid:0.21 CTAB:0.16 dodecylmethacrylate (hydrophobic monomer): 0.02 hexanediolmethacrylate (crosslinker) 0.08 7-octenyltrimethoxysilane: 0.02 initiator. The initiator is benzoin dimethyl ether when polymerization is photoinitiated and 1,1′-azobis(1-cyclohexane) carbonitrile when polymerization is thermally initiated. As before, these materials are combined in a single solution. The added ingredients introduce additional variables that are increasingly difficult to control for repeatability purposes.

Different solvents and hydrophobic polymers may be used with varying evaporation rates to provide mesoporous materials with porosity exceeding 50%. For example, TEOS sol-gels may use anionic, cationic, nonionic, or block copolymer surfactants, as described in U.S. Pat. No. 6,270,846 to Brinker et al. Sol-gels are prepared using, for example, alkoxy silanes, or metal alkoxides such as titanium butoxide, zirconium n-butoxide, aluminum iso-propoxide and mixtures thereof. The hydrophobic polymer may include polypropylene oxide, and/or polypropylene glycol dimethacrylate. Solvents may include alcohol, formamide, tetrahydrofuran, sulfates, sulfionates, phosphates, carboxylic acids, alkylammonium salts, gemini surfactants, cetylethylpiperidinium salts, dialkyldimethylammonium, primary amines, poly(oxyethylene) oxides, octaethylene glycol monodecyl ether, and octaethylene glycol monohexadecyl ether. Thus, complex metal oxides may be made in addition to silica-based materials, and the film properties may be varied through differing use of hydrophobic polymers, solvents, and process conditions. Again, the combination of additional materials in a solution introduces additional variables that are increasingly difficult to control repeatably.

U.S. Pat. No. 5,789,027 issued to Watkins et al. describes the use of chemical fluid depositon processes involving supercritical solvents to deposit metals and complex metal oxides. Mention is made of infusing preformed mesoporous materials with liquid precursor dissolved in supercritical solvents.

Silica-based films, especially those made from TEOS precursors, are often hydroxylated. Dehydroxylation of these films provides a film having a relatively low dielectric constant (k<3) that is stable at ambient humid conditions. As discussed in U.S. Pat. No. 6,329,017 to Liu et al., dehydroxylation may be accomplished utilizing post-formation processing with silane, for example, by exposure to liquid or vapor of trimethyl iodosilane, trimethyl chlorosilane, dimethyl dimethoxy silane, hexamethyl disilazane, dimethyl dichlorosilane, hexaphenyl disilazane, acetaldehyde, and/or diphenyltetramethylsilazane.

### SUMMARY

The art is advanced to overcome the problems outlined above by providing an automated system that produces mesoporous materials with high repeatability and reliability. These advantages are obtained by using an automated sequential system to accomplish template deposition, followed by infusion of a precursor that segregates to form a mesoporous matrix, especially where a supercritical fluid is used for the infusion.

According to one embodiment, an automated system for deposition of mesoporous material on a substrate includes a plurality of processing chambers. In combination, the processing chambers are capable of forming the mesoporous material on the substrate. A conveyance, such as a robotic arm or wafer conveyor, transports the substrate between the plurality of processing chambers. A programmable controller is configured to govern automated processing of the substrate through the plurality of processing chambers in forming the mesoporous material on the substrate. For example, the controller can implement program instructions that define the temperature, pressure, and duration of events in each processing chamber. The plurality of processing chambers include at least one template deposition chamber that is configured to apply a mesoporous template-forming material to the substrate. Another processing chamber is a supercritical infusion chamber configured to infuse the mesoporous template-forming material with a mesoporous matrix-forming material.

The automated system is capable of providing mesoporus silica materials having excellent electrical properties with high uniformity and repeatability. For example, mesoporous silica materials having dielectric constants of k=1.78 and/or hardnesses of 0.8 GPa may be obtained.

In embodiments where the conveyance is a robotic arm assembly, the substrate may be a wafer that is manipulated by a wafer handling device, such as gripper jaws or a vacuum wand. The robotic arm may travel in any direction, i.e., it may convey wafers sequentially or nonsequentially through all of the process stations. There may be more than one robotic arm assembly to carry multiple wafers at one time.

Additional aspects of the automated sequential system optionally include providing the template deposition chamber with a variety of elements that facilitate deposition of the template-forming material. One such element is, for example, a wafer-coating device, such as a spin-coater, a print coater, or a chemical vapor deposition system. The wafer coating device deposits a thin film of a mesoscale structured template. A field generator can be positioned to orient the mesoscale domains of the template-forming material in a predetermined orientation. In additional embodiments, the template deposition chamber includes a heater or optical source that the controller uses for selectively initiating a polymerization reaction in the mesoporous template-forming material. The template deposition chamber can contain or be provided with a precursor liquid or other fluid capable of forming a mesoporous polymer template.

In other embodiments, the supercritical infusion chamber contains elements that facilitate deposition of the matrix-forming material. One such element is, for example, a fluid that is maintained at or near a supercritical state. The term “supercritical” is hereby defined to mean a state where a gas is heated above a critical temperature such that the gas cannot be liquefied by pressure. The fluid may be a polar or nonpolar gas to assist solubility of precursor liquids. By way of example, a nonpolar gas is carbon dioxide, a halogen gas, a noble gas or an alkane gas. It is advantageous to dissolve a matrix-forming precursor liquid in the supercritical fluid because this permits the supercritical fluid to carry or infuse the precursor into the template where the precursor preferentially segregates into one phase of the mesostructured template. In some embodiments, precursor vaporization is facilitated by fitting the supercritical infusion chamber with a chemical vapor deposition device configured to operate at supercritical or non-supercritical conditions. In additional embodiments, the supercritical infusion chamber contains a field generator positioned to orient mesoporous domains of the mesoporous matrix-forming material in a predetermined matrix orientation.

In some embodiments, the mesoporous matrix-forming precursor liquid used in the supercritical infusion chamber is a precursor liquid capable of forming silica. The precursor liquid is alternatively designed to form other materials, such as a complex metal oxide or a metal nitride. Additional processing, such as annealing under appropriate conditions, produces a final matrix of silica, metal oxide, complex metal oxides, metal nitrides, complex metal nitrides, or other materials. In other embodiments, infusion takes place under subcritical conditions. The matrix-forming precursor may be delivered in either the liquid or gas phase, either neat or in solution, and penetrates into the template.

In still other embodiments, a curing chamber is used to cure the matrix-forming material, e.g., by thermal action in an oxygen atmosphere. The curing chamber or a separate chamber may also function as a detemplating chamber that optionally removes the template-forming material, for example, by thermal, chemical or plasma activity. Accordingly, the mesoporous matrix remains on the substrate after the template is removed. In additional embodiments, a dehydroxylation chamber is used to dehydroxylate the mesoporous matrix, e.g., by the action of hexamethyl disilazane (HMDS). A capping chamber is optionally used to form a cap of SiO₂ or another material over the dehydroxylated matrix.

The foregoing automated deposition system may be used in a method of producing mesoporous materials on a substrate. One such method includes the steps of processing the substrate under instructions from automated controller to form the mesoporous materials on the substrate through the use of a plurality of process chambers, and transporting the substrate among the plurality of sequential processing chambers. The plurality of process chambers include a template deposition chamber and an infusion chamber, such that the step of processing includes using the template deposition chamber to deposit a template, and using the infusion chamber to infuse the template with a matrix-forming material under either supercritical or subcritical conditions.

Upon reading the following detailed description, in addition to the accompanying drawings, those skilled in the art will appreciate that additional objects and advantages are disclosed.

### DESCRIPTION OF THE DRAWINGS

FIG. 1 is a block schematic diagram of one automated deposition system that may be used to deposit mesoporous materials on a substrate;

FIG. 2 is a schematic diagram of one processing chamber for use in the automated deposition system;

FIG. 3 is a plot of X-ray diffraction data for a mesoporous silica; and

FIG. 4 is a scanning electron micrograph of a mesoporous silica.

### DETAILED DESCRIPTION

One way of forming mesoporous materials is to deposit separate solutions including a first solution that deposits a mesostructured template and a second solution that forms the mesoporous matrix based on the template. The template organizes itself into an initial biphasic mesostructured framework that defines the mesoporous structure. Template deposition is followed by a second solution that infuses a matrix-forming precursor, such as TEOS, which preferentially segregates into one phase of the mesostructured template. The template may then be removed to produce a mesoporous material. Infusion of the matrix-forming precursor benefits from solvents in a supercritical state, which enhance the infusion capacity of the solvent. At present no apparatus is commercially available to implement automated mesoporous deposition processes using this sequential method for forming mesoporous films. Once the template has been formed, and as an alternative to supercritical deposition processes, the matrix-forming precursor is optionally deposited in a separate step by spin-on deposition, print-on deposition or screening, chemical vapor deposition, or plasma enhanced chemical vapor deposition.

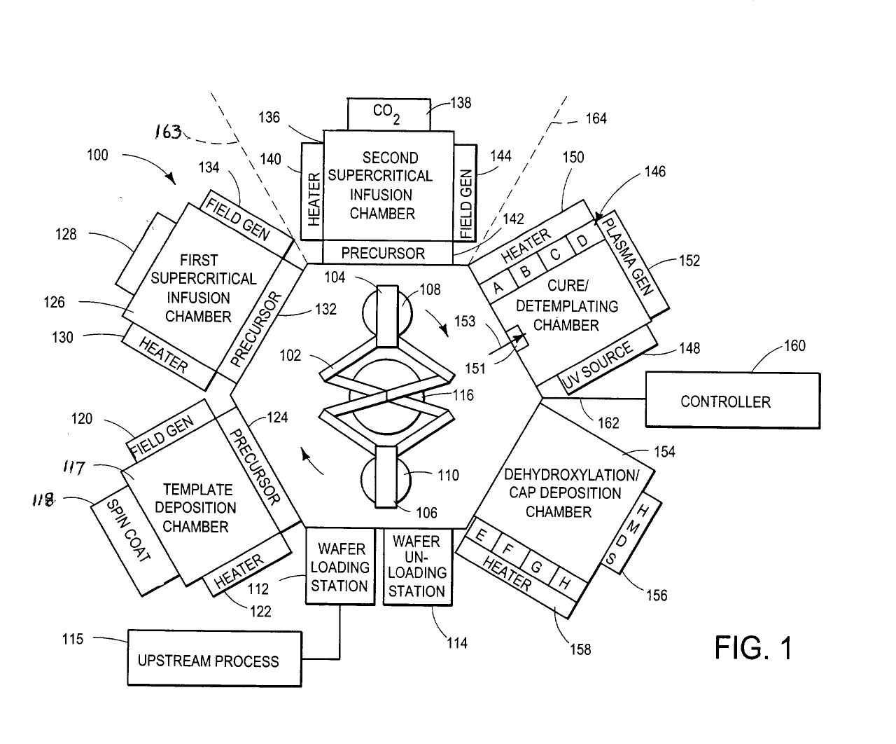

FIG. 1 is a block diagram showing elements of an automated deposition system 100 for use in forming mesoporous materials. The automated deposition system 100 is shown by way of example and not by limitation. The automated deposition system 100 contains a centrally located extensible dual-robotic arm assembly 102, for example, using robotically controlled vacuum wands 104 and 106 to carry silicon wafers 108 and 110. The silicon wafers 108 and 110 are used as deposition substrates through sequential downstream processing interposed between a wafer loading station 112 and a wafer unloading station 114. A central rotatable platform 116 conveys the wafers 108 and 110 for delivery to, and pick up from, any position within the automated deposition system 100. The central rotatable platform 116 can be raised and lowered vertically by pneumatic or hydraulic action to provide a three dimensional range of motion.

The wafer loading station 112 contains a plurality of wafers, such as wafers 108, 110, that have been pre-processed according to conventional processes to receive the deposition of a mesoporous film. By way of example, deposition may occur on silicon wafers 108, 110 that have been purchased on commercial order and/or which have been subjected to prior deposition processes. Upstream processes 115 can pre-form additional layers or materials on the wafers 108 and 110, such as wiring layers, ion-implanted silicon, barrier layers, and/or ferroelectric materials. Other examples of materials deposited by upstream processes 115 include, for example, embedded circuits or layers covered by capping layers, such as silicon carbide or silicon nitride capping layers. Substrates that may be used in place of wafers 108 and 110 include, for example, glass sheets, polymer webs, gallium nitride, metal, metal oxide, gallium arsenide, semiconductor materials, optical lenses, molecular sieve substrates, sensor probes, and/or any other article that benefits from the deposition of mesoporous materials. The wafer loading station 112 acts as a buffer to hold the made-ready wafers, such as wafers 108 and 110, until they are needed.

As shown in FIG. 1, a template deposition chamber 117 provides the first processing station downstream of the wafer loading station 112. The template deposition chamber 117 contains a coating device of a type conventionally used to deposit precursor liquids on substrates. By way of example, template deposition chamber 117 contains a spin-coater 118. Alternatively, the spin-coater 118 may be a print-on device such as that described in U.S. Pat. No. 6,436,843 issued to Meinhold, et al., or a chemical vapor deposition device. A field generator 120 is optionally charged to emanate an electrical field that orders domains, e.g., micelle structures, within the template and/or aligns electrostatic domains in the template material relative to the wafer substrate. A heater 122, such as a convection oven or wafer bake plate, controls the temperature of the substrate while it is in the template deposition chamber 117 to selectively evaporate solvent from the template-forming precursor liquid 124. The template deposition chamber may further provide a means to control the vapor phase composition in order to direct the ordering of the mesostructure at the film-vapor interface.

According to one embodiment, a template-forming precursor liquid 124 contains a polymer or mixture of polymers dissolved in a solvent that evaporates to leave a desired mesoscale structure, for example, a polyethylene oxide-polypropylene oxide-polyethylene oxide block copolymer in ethanol. In another example, the template-forming precursor liquid 124 forms a block copolymer from resins that undergo a polymerization reaction with micelles that coalesce to yield a mesoscale structure. The template-forming precursor liquid 124 reacts and/or dries to provide a mesostructured matrix. Solvent is dried through use of the heater 122 to leave a mesostructured template on the deposition substrates, such as wafers 108 and 110.

A first supercritical infusion chamber 126 follows template deposition chamber 117. With the mesostructured template material formed in the template deposition chamber 117, robotic arm assembly 102 conveys wafer 108 or 110 into the first supercritical infusion chamber 126. A solvent, such as carbon dioxide 128 in a supercritical state for example, at a temperature greater than 31° C. and a pressure greater than 74 bar, dissolves a first matrix-forming precursor liquid 132. Heater 130 is useful for maintaining the supercritical state. Heater 130 is, for example, a convection oven, individual or multiple wafer bake plates, or heated reactor walls. The first matrix-forming precursor liquid 132 is dissolved in or premixed with the carbon dioxide 128 prior to introducing either fluid into the first supercritical infusion chamber 126, or the two fluids may be introduced separately and/or sequentially. A field generator 134 is optionally used to orient matrix domains relative to the wafer 108 or 110, and/or to produce an ordered structure in the mesoporous material. Thus, the robotic arm assembly 102 is controllable to deliver wafers 108, 110 between successive stations, such as template deposition chamber 117 and first supercritical infusion chamber 126, while preserving a predetermined orientation between the wafers 108, 110 and the field generator 134. The first supercritical infusion chamber 126 can operate upon single wafers or batches of wafers. The function of first supercritical infusion chamber 126 is to infuse a first matrix-forming precursor liquid 132 into the template that has been formed on a substrate, such as wafer 108 or 110, by the action of template deposition chamber 116. In alternative embodiments, the first supercritical infusion chamber 126 may be a spin coater, print-on device such as that described in U.S. Pat. No. 6,436,843 issued to Meinhold, et al., a liquid immersion bath, or a chemical vapor deposition device.

Where mesoporous silica is desired, the precursor liquid 132 may be a silica-forming compound, for example, TEOS, an organic alkoxysilane such as methyl triethoxysilane, a bridged siloxane such as bis-triethoxysilylethane or bis-triethoxysilylmethane, mixtures of these precursors, or any other silica-forming compound. One example of the first precursor liquid 132 is TEOS dissolved to a 2% by weight concentration in the carbon dioxide solvent. Alternatively, where mesoporous metal oxides are desired, a metal-organic ligand may be used where the metal-organic ligand is compatible with the deposition chemistry. For example, metal alkoxides may be used with or without sol-gel forming acid catalysts. In like manner, metal carboxylates and/or metal ketonates may be used. Compatible liquid solvents, such as alkanes, cycloalkanes, carboxylic acids, may be used to adjust the viscosity and/or partial pressure of vapor from the first matrix-forming precursor liquid 132.

A second supercritical infusion chamber 136 can be added to balance throughput of the various process modules, by duplicating the functionality of first supercritical infusion chamber 126. A solvent, such as carbon dioxide 138, can dissolve a second matrix-forming precursor liquid 142, which may be the same as or different from the first matrix-forming precursor liquid 132. The carbon dioxide 138 is pressurized and heated to provide a supercritical state. Heater 140 is useful for maintaining the supercritical state at a given pressure. Heater 140 may be a convection oven, individual or multiple wafer bake plates, or heated reactor walls. The second matrix-forming precursor liquid 142 may be dissolved in or premixed with the carbon dioxide 138 prior to introducing either fluid into the second supercritical infusion chamber 136, or the two fluids may be added separately and/or sequentially. A field generator 144 is optionally used to orient domains relative to the wafer 108, 110, and/or to produce an ordered structure in the mesoporous material. In the case where the second matrix-forming precursor liquid 142 is different from the first matrix-forming precursor liquid 132, processing wafers 108, 110 sequentially in both the first supercritical infusion chamber 126 and the second supercritical infusion chamber 136 may facilitate the making of stratified or dual-composite mesoporous structures that differ in composition.

Alternatively, the second supercritical infusion chamber 136 may also provide a means to partially reextract the infused precursor to provide better control over the pore wall properties. For example, after the infusion reaction has progressed sufficiently to provide structural integrity, any remaining unreacted amounts of the second matrix-forming precursor liquid 142 may be extracted from the film, thus leaving less dense walls with a lower intrinsic dielectric constant. The second supercritical infusion chamber 136 may also be used for detemplating by chemical reaction of an additive in the supercritical fluid with the template material. The additive breaks down the template material which may be then extracted into the supercritical fluid. Additionally, the second supercritical infusion chamber 136 may be used for dehydroxylation of the detemplated film. For example, the wafer may be exposed to HMDS dissolved in supercritical CO₂. The second supercritical infusion chamber 136 may also provide cyclic pressurization and repressurization cycles to ensure enhanced infusion of both the first matrix-forming precursor liquid 132 and the second matrix-forming precursor liquid 142 into the block copolymer matrix produced in the template deposition chamber 116.

In alternative embodiments, the second supercritical infusion chamber 136 may be a spin coater, print-on device such as that described in U.S. Pat. No. 6,436,843 issued to Meinhold, et al., a liquid immersion bath, or a chemical vapor deposition device.

As shown in the embodiment of FIG. 1, the second supercritical infusion chamber 136 is followed by a cure and detemplating chamber 146. It may be necessary or desirable to cure the wafers 108 and 110 after processing in the first supercritical infusion chamber 126 and/or the second supercritical infusion chamber 136. For example, where the first matrix-forming precursor liquid 132 or the second matrix-forming precursor liquid 142 is polymerizable, polymerization may be initiated by photoinitiation using ultraviolet source 148, thermal initiation using heater 150, or polymerization may inherently occur over time. Cross-linking of the silica network may be performed by exposing the wafers 108 or 110 to a predetermined environment over time such that organic ligands from the first matrix-forming precursor liquid 132 and the second matrix-forming precursor liquid 142 form leaving groups with associated formation of Si—Si and/or Si—O bonds in the remaining groups. By way of example, this may be accomplished by calcination in a multi-stage heating profile that dries and/or calcines, e.g., by exposing the wafers to an oxygen atmosphere in a ramped or staged heating profile. The mesoporous material may benefit from a ramped heating profile that increases temperature using heater 150 up to, for example, 400° C. or another temperature that is suitable for complete oxidation of materials formed from the precursor liquid 132 and/or precursor liquid 142. Calcination of the template material for detemplatating purposes may occur in an oxygen atmosphere at temperatures ranging from 50° C. to 700° C.

The cure and detemplating chamber 146 may have a dual functionality, such as one that first cures the silica network by establishing Si—O bonds and then removes the template material, e.g., by thermal treatment, plasma exposure, radiation, solvent extraction by a liquid or supercritical solvent, other destructive removal, or chemical extraction. The heater 150 is, for example, a series of segments A, B, C, D, which may be convection ovens, wafer bake plates, or rapid thermal processing units. Heater 150 may be configured in a ramp-stepped heating profile at segments A-D in which the matrix material is cured and the template material is calcined. Curing and/or detemplatating may also be accomplished using a plasma. A showerhead 151 can be used to introduce a gas flow 153, for example, low pressure nitrogen or hydrogen, that facilitates operation of the plasma generator 152.

In alternative embodiments, the plasma generator 152 may be an electron gun capable of generating a beam of sufficient intensity to accomplish curing. Another process option is to use the ultraviolet source 148 at a sufficient intensity for detemplatating purposes. Detemplatating may also be accomplished, for example, in the second supercritical infusion chamber 136 by using a supercritical solvent to extract the template material, i.e., by supercritical extraction.

The silica network formed from TEOS or other silicon-containing precursors may terminate with Si—OH groups. It may be desirable to replace the hydroxyl moiety with a non-polar group, which produces a hydrophobic termination and reduces the dielectric constant of the mesoporous material. Dehydroxylation may be accomplished by exposure to liquid or vapor forms of a variety of chemicals, as described in the '017 patent to Liu et al. According to one embodiment, the dehydroxylation/cure chamber 154 uses vapor from a dexydroxylation agent, such as HMDS 156, to accomplish dehydroxylation. Dehydroxylation may also be accomplished by contact with a suitable liquid dehydroxylation agent, or by dissolving a dehydroxylation agent in a supercritical solvent, for example, in the second supercritical infusion chamber 136.

Integration schemes for low k dielectrics may require a nonporous cap, such as a silicon dioxide, silicon nitride, or silicon carbide cap, to be deposited over the low dielectric film. Thus, the dehydroxylation/cap deposition chamber 154 may include a conventional apparatus for this purpose, such as a Sequel™ or Vector system available on commercial order from Novellus Systems of San Jose, Calif. The Sequel™ and Vector systems are multistage plasma enhanced chemical vapor deposition (PECVD) systems that may be configured to dehydroxylate using HMDS and then produce an oxide, nitride, or carbide cap.

Following detemplatating, the second supercritical infusion chamber 136 may be used to infuse the remaining matrix material with precursor liquid 142 to form a dual mesostructured material on wafers 108, 110, which may be again processed through the cure/detemplating chamber 146 and the dehydroxylation/cap deposition chamber 154.

Heater 158 is, for example, a series of segments E, F, G, H, which may be convection ovens, wafer bake plates, or rapid thermal processing units. Heater 158 may be configured to provide a ramp-stepped heating profile at segments in which the matrix material is successively processed at 150° C.-450° C. to dry moisture, then dehydroxylate using HMDS 156, and finally to deposit an oxide cap.

A programmable controller 160 connects with all other elements of the automated depositon system 100 through system bus 162, and is programmed with instructions that govern any process condition in the chambers 117, 126, 136, 146, and 154. For example, the programmable controller 160 may govern the temperature, pressure, and duration of processing. Controller 160 may also govern the motion of robotic arm assembly 102 according to preprogrammed movements. These movements need not necessarily convey wafers 108, 110 sequentially through processing stations 117, 126, 136, 146, 154, and can convey wafers through these processing stations in any order.

It will be appreciated that FIG. 1 demonstrates the automated depositon system 100 by way of example and not by limitation. Changes may be made as desired to the structure shown in FIG. 1. For example, the second supercritical infusion chamber 136 may be removed by disconnecting the same at lines 163 and 164. Accordingly, the automated depositon system 100 may be deployed in a ring, as depicted in FIG. 1, in a linear system that is disconnected at line 163 or 164 (or any other linear arrangement), or in a dispersed system wherein the processing stations are not physically coupled with each other. Alternatively, additional processing stations may be added at lines 163 or 164, or any other place in the automated system 100. The dual-robotic arm assembly 102 may have any number of robotic arms, such as one, two or three arms. The dual robotic arm assembly 102 may be controlled to deliver wafers 108, 110 to any position within the automated depositon system 100 in any order.

As described above, the automated deposition system 100 may be configured and operated to provide various combinations of process steps accomplished by different means. By way of example, Table 1 below demonstrates some of the process permutations that may be achieved, in combination, under the selective control of controller 162. The capability to select various combinations of process instrumentalities provides flexibility rendering the automated depositon system 100 readily adaptable to any process need.

TABLE 1
AUTOMATED PROCESS COMBINATIONS

| Template | | | Template | Dehydroxylation |
|---|---|---|---|---|
| Deposition | | Optional Cure | Removal | Technique Used In |
| Technique Used In | Matrix Deposition | Technique Used | Technique Used | The |
| The Template | Technique Used In | In The Cure And | In The Cure And | Dehydroxylation/cap |
| Deposition | The First Supercritical | Detemplating | Detemplating | deposition chamber |
| Chamber 117 | Infusion Chamber 126 | Chamber 146 | Chamber 146 | 154 |
| Spin-on | Spin-on | Thermal | Thermal | Vapor |
| Spin-on | Spin-on | Thermal | Thermal | Liquid |
| Spin-on | Spin-on | Thermal | Thermal | Supercritical |
| Spin-on | Spin-on | Thermal | Plasma | Vapor |
| Spin-on | Spin-on | Thermal | Plasma | Liquid |
| Spin-on | Spin-on | Thermal | Plasma | Supercritical |
| Spin-on | Spin-on | Thermal | Supercritical | Vapor |
| | | | Extraction | |
| Spin-on | Spin-on | Thermal | Supercritical | Liquid |
| | | | Extraction | |
| Spin-on | Spin-on | Thermal | Supercritical | Supercritical |
| | | | Extraction | |
| Spin-on | Spin-on | Thermal | UV | Vapor |
| Spin-on | Spin-on | Thermal | UV | Liquid |
| Spin-on | Spin-on | Thermal | UV | Supercritical |
| Spin-on | Spin-on | Plasma | Thermal | Vapor |
| Spin-on | Spin-on | Plasma | Thermal | Liquid |
| Spin-on | Spin-on | Plasma | Thermal | Supercritical |
| Spin-on | Spin-on | Plasma | Plasma | Vapor |
| Spin-on | Spin-on | Plasma | Plasma | Liquid |
| Spin-on | Spin-on | Plasma | Plasma | Supercritical |
| Spin-on | Spin-on | Plasma | Supercritical | Vapor |
| | | | Extraction | |
| Spin-on | Spin-on | Plasma | Supercritical | Liquid |
| | | | Extraction | |
| Spin-on | Spin-on | Plasma | Supercritical | Supercritical |
| | | | Extraction | |
| Spin-on | Spin-on | Plasma | UV | Vapor |
| Spin-on | Spin-on | Plasma | UV | Liquid |
| Spin-on | Spin-on | Plasma | UV | Supercritical |
| Spin-on | Spin-on | UV | Thermal | Vapor |
| Spin-on | Spin-on | UV | Thermal | Liquid |
| Spin-on | Spin-on | UV | Thermal | Supercritical |
| Spin-on | Spin-on | UV | Plasma | Vapor |
| Spin-on | Spin-on | UV | Plasma | Liquid |
| Spin-on | Spin-on | UV | Plasma | Supercritical |
| Spin-on | Spin-on | UV | Supercritical | Vapor |
| | | | Extraction | |
| Spin-on | Spin-on | UV | Supercritical | Liquid |
| | | | Extraction | |
| Spin-on | Spin-on | UV | Supercritical | Supercritical |
| | | | Extraction | |
| Spin-on | Spin-on | UV | UV | Vapor |
| Spin-on | Spin-on | UV | UV | Liquid |
| Spin-on | Spin-on | UV | UV | Supercritical |
| Spin-on | Spin-on | Electron beam | Thermal | Vapor |
| Spin-on | Spin-on | Electron beam | Thermal | Liquid |
| Spin-on | Spin-on | Electron beam | Thermal | Supercritical |
| Spin-on | Spin-on | Electron beam | Plasma | Vapor |
| Spin-on | Spin-on | Electron beam | Plasma | Liquid |
| Spin-on | Spin-on | Electron beam | Plasma | Supercritical |
| Spin-on | Spin-on | Electron beam | Supercritical | Vapor |
| | | | Extraction | |
| Spin-on | Spin-on | Electron beam | Supercritical | Liquid |
| | | | Extraction | |
| Spin-on | Spin-on | Electron beam | Supercritical | Supercritical |
| | | | Extraction | |
| Spin-on | Spin-on | Electron beam | UV | Vapor |
| Spin-on | Spin-on | Electron beam | UV | Liquid |
| Spin-on | Spin-on | Electron beam | UV | Supercritical |
| Spin-on | Print-on | Thermal | Thermal | Vapor |
| Spin-on | Print-on | Thermal | Thermal | Liquid |
| Spin-on | Print-on | Thermal | Thermal | Supercritical |
| Spin-on | Print-on | Thermal | Plasma | Vapor |
| Spin-on | Print-on | Thermal | Plasma | Liquid |
| Spin-on | Print-on | Thermal | Plasma | Supercritical |
| Spin-on | Print-on | Thermal | Supercritical | Vapor |
| | | | Extraction | |
| Spin-on | Print-on | Thermal | Supercritical | Liquid |
| | | | Extraction | |
| Spin-on | Print-on | Thermal | Supercritical | Supercritical |
| | | | Extraction | |
| Spin-on | Print-on | Thermal | UV | Vapor |
| Spin-on | Print-on | Thermal | UV | Liquid |
| Spin-on | Print-on | Thermal | UV | Supercritical |
| Spin-on | Print-on | Plasma | Thermal | Vapor |
| Spin-on | Print-on | Plasma | Thermal | Liquid |
| Spin-on | Print-on | Plasma | Thermal | Supercritical |
| Spin-on | Print-on | Plasma | Plasma | Vapor |
| Spin-on | Print-on | Plasma | Plasma | Liquid |
| Spin-on | Print-on | Plasma | Plasma | Supercritical |
| Spin-on | Print-on | Plasma | Supercritical | Vapor |
| | | | Extraction | |
| Spin-on | Print-on | Plasma | Supercritical | Liquid |
| | | | Extraction | |
| Spin-on | Print-on | Plasma | Supercritical | Supercritical |
| | | | Extraction | |
| Spin-on | Print-on | Plasma | UV | Vapor |
| Spin-on | Print-on | Plasma | UV | Liquid |
| Spin-on | Print-on | Plasma | UV | Supercritical |
| Spin-on | Print-on | UV | Thermal | Vapor |
| Spin-on | Print-on | UV | Thermal | Liquid |
| Spin-on | Print-on | UV | Thermal | Supercritical |
| Spin-on | Print-on | UV | Plasma | Vapor |
| Spin-on | Print-on | UV | Plasma | Liquid |
| Spin-on | Print-on | UV | Plasma | Supercritical |
| Spin-on | Print-on | UV | Supercritical | Vapor |
| | | | Extraction | |
| Spin-on | Print-on | UV | Supercritical | Liquid |
| | | | Extraction | |
| Spin-on | Print-on | UV | Supercritical | Supercritical |
| | | | Extraction | |
| Spin-on | Print-on | UV | UV | Vapor |
| Spin-on | Print-on | UV | UV | Liquid |
| Spin-on | Print-on | UV | UV | Supercritical |
| Spin-on | Print-on | Electron beam | Thermal | Vapor |
| Spin-on | Print-on | Electron beam | Thermal | Liquid |
| Spin-on | Print-on | Electron beam | Thermal | Supercritical |
| Spin-on | Print-on | Electron beam | Plasma | Vapor |
| Spin-on | Print-on | Electron beam | Plasma | Liquid |
| Spin-on | Print-on | Electron beam | Plasma | Supercritical |
| Spin-on | Print-on | Electron beam | Supercritical | Vapor |
| | | | Extraction | |
| Spin-on | Print-on | Electron beam | Supercritical | Liquid |
| | | | Extraction | |
| Spin-on | Print-on | Electron beam | Supercritical | Supercritical |
| | | | Extraction | |
| Spin-on | Print-on | Electron beam | UV | Vapor |
| Spin-on | Print-on | Electron beam | UV | Liquid |
| Spin-on | Print-on | Electron beam | UV | Supercritical |
| Spin-on | Supercritical Infusion | Thermal | Thermal | Vapor |
| Spin-on | Supercritical Infusion | Thermal | Thermal | Liquid |
| Spin-on | Supercritical Infusion | Thermal | Thermal | Supercritical |
| Spin-on | Supercritical Infusion | Thermal | Plasma | Vapor |
| Spin-on | Supercritical Infusion | Thermal | Plasma | Liquid |
| Spin-on | Supercritical Infusion | Thermal | Plasma | Supercritical |
| Spin-on | Supercritical Infusion | Thermal | Supercritical | Vapor |
| | | | Extraction | |
| Spin-on | Supercritical Infusion | Thermal | Supercritical | Liquid |
| | | | Extraction | |
| Spin-on | Supercritical Infusion | Thermal | Supercritical | Supercritical |
| | | | Extraction | |
| Spin-on | Supercritical Infusion | Thermal | UV | Vapor |
| Spin-on | Supercritical Infusion | Thermal | UV | Liquid |
| Spin-on | Supercritical Infusion | Thermal | UV | Supercritical |
| Spin-on | Supercritical Infusion | Plasma | Thermal | Vapor |
| Spin-on | Supercritical Infusion | Plasma | Thermal | Liquid |
| Spin-on | Supercritical Infusion | Plasma | Thermal | Supercritical |
| Spin-on | Supercritical Infusion | Plasma | Plasma | Vapor |
| Spin-on | Supercritical Infusion | Plasma | Plasma | Liquid |
| Spin-on | Supercritical Infusion | Plasma | Plasma | Supercritical |
| Spin-on | Supercritical Infusion | Plasma | Supercritical | Vapor |
| | | | Extraction | |
| Spin-on | Supercritical Infusion | Plasma | Supercritical | Liquid |
| | | | Extraction | |
| Spin-on | Supercritical Infusion | Plasma | Supercritical | Supercritical |
| | | | Extraction | |
| Spin-on | Supercritical Infusion | Plasma | UV | Vapor |
| Spin-on | Supercritical Infusion | Plasma | UV | Liquid |
| Spin-on | Supercritical Infusion | Plasma | UV | Supercritical |
| Spin-on | Supercritical Infusion | UV | Thermal | Vapor |
| Spin-on | Supercritical Infusion | UV | Thermal | Liquid |
| Spin-on | Supercritical Infusion | UV | Thermal | Supercritical |
| Spin-on | Supercritical Infusion | UV | Plasma | Vapor |
| Spin-on | Supercritical Infusion | UV | Plasma | Liquid |
| Spin-on | Supercritical Infusion | UV | Plasma | Supercritical |
| Spin-on | Supercritical Infusion | UV | Supercritical | Vapor |
| | | | Extraction | |
| Spin-on | Supercritical Infusion | UV | Supercritical | Liquid |
| | | | Extraction | |
| Spin-on | Supercritical Infusion | UV | Supercritical | Supercritical |
| | | | Extraction | |
| Spin-on | Supercritical Infusion | UV | UV | Vapor |
| Spin-on | Supercritical Infusion | UV | UV | Liquid |
| Spin-on | Supercritical Infusion | UV | UV | Supercritical |
| Spin-on | Supercritical Infusion | Electron beam | Thermal | Vapor |
| Spin-on | Supercritical Infusion | Electron beam | Thermal | Liquid |
| Spin-on | Supercritical Infusion | Electron beam | Thermal | Supercritical |
| Spin-on | Supercritical Infusion | Electron beam | Plasma | Vapor |
| Spin-on | Supercritical Infusion | Electron beam | Plasma | Liquid |
| Spin-on | Supercritical Infusion | Electron beam | Plasma | Supercritical |
| Spin-on | Supercritical Infusion | Electron beam | Supercritical | Vapor |
| | | | Extraction | |
| Spin-on | Supercritical Infusion | Electron beam | Supercritical | Liquid |
| | | | Extraction | |
| Spin-on | Supercritical Infusion | Electron beam | Supercritical | Supercritical |
| | | | Extraction | |
| Spin-on | Supercritical Infusion | Electron beam | UV | Vapor |
| Spin-on | Supercritical Infusion | Electron beam | UV | Liquid |
| Spin-on | Supercritical Infusion | Electron beam | UV | Supercritical |
| Spin-on | Liquid Immersion | Thermal | Thermal | Vapor |
| Spin-on | Liquid Immersion | Thermal | Thermal | Liquid |
| Spin-on | Liquid Immersion | Thermal | Thermal | Supercritical |
| Spin-on | Liquid Immersion | Thermal | Plasma | Vapor |
| Spin-on | Liquid Immersion | Thermal | Plasma | Liquid |
| Spin-on | Liquid Immersion | Thermal | Plasma | Supercritical |
| Spin-on | Liquid Immersion | Thermal | Supercritical | Vapor |
| | | | Extraction | |
| Spin-on | Liquid Immersion | Thermal | Supercritical | Liquid |
| | | | Extraction | |
| Spin-on | Liquid Immersion | Thermal | Supercritical | Supercritical |
| | | | Extraction | |
| Spin-on | Liquid Immersion | Thermal | UV | Vapor |
| Spin-on | Liquid Immersion | Thermal | UV | Liquid |
| Spin-on | Liquid Immersion | Thermal | UV | Supercritical |
| Spin-on | Liquid Immersion | Plasma | Thermal | Vapor |
| Spin-on | Liquid Immersion | Plasma | Thermal | Liquid |
| Spin-on | Liquid Immersion | Plasma | Thermal | Supercritical |
| Spin-on | Liquid Immersion | Plasma | Plasma | Vapor |
| Spin-on | Liquid Immersion | Plasma | Plasma | Liquid |
| Spin-on | Liquid Immersion | Plasma | Plasma | Supercritical |
| Spin-on | Liquid Immersion | Plasma | Supercritical | Vapor |
| | | | Extraction | |
| Spin-on | Liquid Immersion | Plasma | Supercritical | Liquid |
| | | | Extraction | |
| Spin-on | Liquid Immersion | Plasma | Supercritical | Supercritical |
| | | | Extraction | |
| Spin-on | Liquid Immersion | Plasma | UV | Vapor |
| Spin-on | Liquid Immersion | Plasma | UV | Liquid |
| Spin-on | Liquid Immersion | Plasma | UV | Supercritical |
| Spin-on | Liquid Immersion | UV | Thermal | Vapor |
| Spin-on | Liquid Immersion | UV | Thermal | Liquid |
| Spin-on | Liquid Immersion | UV | Thermal | Supercritical |
| Spin-on | Liquid Immersion | UV | Plasma | Vapor |
| Spin-on | Liquid Immersion | UV | Plasma | Liquid |
| Spin-on | Liquid Immersion | UV | Plasma | Supercritical |
| Spin-on | Liquid Immersion | UV | Supercritical | Vapor |
| | | | Extraction | |
| Spin-on | Liquid Immersion | UV | Supercritical | Liquid |
| | | | Extraction | |
| Spin-on | Liquid Immersion | UV | Supercritical | Supercritical |
| | | | Extraction | |
| Spin-on | Liquid Immersion | UV | UV | Vapor |
| Spin-on | Liquid Immersion | UV | UV | Liquid |
| Spin-on | Liquid Immersion | UV | UV | Supercritical |
| Spin-on | Liquid Immersion | Electron beam | Thermal | Vapor |
| Spin-on | Liquid Immersion | Electron beam | Thermal | Liquid |
| Spin-on | Liquid Immersion | Electron beam | Thermal | Supercritical |
| Spin-on | Liquid Immersion | Electron beam | Plasma | Vapor |
| Spin-on | Liquid Immersion | Electron beam | Plasma | Liquid |
| Spin-on | Liquid Immersion | Electron beam | Plasma | Supercritical |
| Spin-on | Liquid Immersion | Electron beam | Supercritical | Vapor |
| | | | Extraction | |
| Spin-on | Liquid Immersion | Electron beam | Supercritical | Liquid |
| | | | Extraction | |
| Spin-on | Liquid Immersion | Electron beam | Supercritical | Supercritical |
| | | | Extraction | |
| Spin-on | Liquid Immersion | Electron beam | UV | Vapor |
| Spin-on | Liquid Immersion | Electron beam | UV | Liquid |
| Spin-on | Liquid Immersion | Electron beam | UV | Supercritical |
| Spin-on | CVD | Thermal | Thermal | Vapor |
| Spin-on | CVD | Thermal | Thermal | Liquid |
| Spin-on | CVD | Thermal | Thermal | Supercritical |
| Spin-on | CVD | Thermal | Plasma | Vapor |
| Spin-on | CVD | Thermal | Plasma | Liquid |
| Spin-on | CVD | Thermal | Plasma | Supercritical |
| Spin-on | CVD | Thermal | Supercritical | Vapor |
| | | | Extraction | |
| Spin-on | CVD | Thermal | Supercritical | Liquid |
| | | | Extraction | |
| Spin-on | CVD | Thermal | Supercritical | Supercritical |
| | | | Extraction | |
| Spin-on | CVD | Thermal | UV | Vapor |
| Spin-on | CVD | Thermal | UV | Liquid |
| Spin-on | CVD | Thermal | UV | Supercritical |
| Spin-on | CVD | Plasma | Thermal | Vapor |
| Spin-on | CVD | Plasma | Thermal | Liquid |
| Spin-on | CVD | Plasma | Thermal | Supercritical |
| Spin-on | CVD | Plasma | Plasma | Vapor |
| Spin-on | CVD | Plasma | Plasma | Liquid |
| Spin-on | CVD | Plasma | Plasma | Supercritical |
| Spin-on | CVD | Plasma | Supercritical | Vapor |
| | | | Extraction | |
| Spin-on | CVD | Plasma | Supercritical | Liquid |
| | | | Extraction | |
| Spin-on | CVD | Plasma | Supercritical | Supercritical |
| | | | Extraction | |
| Spin-on | CVD | Plasma | UV | Vapor |
| Spin-on | CVD | Plasma | UV | Liquid |
| Spin-on | CVD | Plasma | UV | Supercritical |
| Spin-on | CVD | UV | Thermal | Vapor |
| Spin-on | CVD | UV | Thermal | Liquid |
| Spin-on | CVD | UV | Thermal | Supercritical |
| Spin-on | CVD | UV | Plasma | Vapor |
| Spin-on | CVD | UV | Plasma | Liquid |
| Spin-on | CVD | UV | Plasma | Supercritical |
| Spin-on | CVD | UV | Supercritical | Vapor |
| | | | Extraction | |
| Spin-on | CVD | UV | Supercritical | Liquid |
| | | | Extraction | |
| Spin-on | CVD | UV | Supercritical | Supercritical |
| | | | Extraction | |
| Spin-on | CVD | UV | UV | Vapor |
| Spin-on | CVD | UV | UV | Liquid |
| Spin-on | CVD | UV | UV | Supercritical |
| Spin-on | CVD | Electron beam | Thermal | Vapor |
| Spin-on | CVD | Electron beam | Thermal | Liquid |
| Spin-on | CVD | Electron beam | Thermal | Supercritical |
| Spin-on | CVD | Electron beam | Plasma | Vapor |
| Spin-on | CVD | Electron beam | Plasma | Liquid |
| Spin-on | CVD | Electron beam | Plasma | Supercritical |
| Spin-on | CVD | Electron beam | Supercritical | Vapor |
| | | | Extraction | |
| Spin-on | CVD | Electron beam | Supercritical | Liquid |
| | | | Extraction | |
| Spin-on | CVD | Electron beam | Supercritical | Supercritical |
| | | | Extraction | |
| Spin-on | CVD | Electron beam | UV | Vapor |
| Spin-on | CVD | Electron beam | UV | Liquid |
| Spin-on | CVD | Electron beam | UV | Supercritical |
| Print-on | Spin-on | Thermal | Thermal | Vapor |
| Print-on | Spin-on | Thermal | Thermal | Liquid |
| Print-on | Spin-on | Thermal | Thermal | Supercritical |
| Print-on | Spin-on | Thermal | Plasma | Vapor |
| Print-on | Spin-on | Thermal | Plasma | Liquid |
| Print-on | Spin-on | Thermal | Plasma | Supercritical |
| Print-on | Spin-on | Thermal | Supercritical | Vapor |
| | | | Extraction | |
| Print-on | Spin-on | Thermal | Supercritical | Liquid |
| | | | Extraction | |
| Print-on | Spin-on | Thermal | Supercritical | Supercritical |
| | | | Extraction | |
| Print-on | Spin-on | Thermal | UV | Vapor |
| Print-on | Spin-on | Thermal | UV | Liquid |
| Print-on | Spin-on | Thermal | UV | Supercritical |
| Print-on | Spin-on | Plasma | Thermal | Vapor |
| Print-on | Spin-on | Plasma | Thermal | Liquid |
| Print-on | Spin-on | Plasma | Thermal | Supercritical |
| Print-on | Spin-on | Plasma | Plasma | Vapor |
| Print-on | Spin-on | Plasma | Plasma | Liquid |
| Print-on | Spin-on | Plasma | Plasma | Supercritical |
| Print-on | Spin-on | Plasma | Supercritical | Vapor |
| | | | Extraction | |
| Print-on | Spin-on | Plasma | Supercritical | Liquid |
| | | | Extraction | |
| Print-on | Spin-on | Plasma | Supercritical | Supercritical |
| | | | Extraction | |
| Print-on | Spin-on | Plasma | UV | Vapor |
| Print-on | Spin-on | Plasma | UV | Liquid |
| Print-on | Spin-on | Plasma | UV | Supercritical |
| Print-on | Spin-on | UV | Thermal | Vapor |
| Print-on | Spin-on | UV | Thermal | Liquid |
| Print-on | Spin-on | UV | Thermal | Supercritical |
| Print-on | Spin-on | UV | Plasma | Vapor |
| Print-on | Spin-on | UV | Plasma | Liquid |
| Print-on | Spin-on | UV | Plasma | Supercritical |
| Print-on | Spin-on | UV | Supercritical | Vapor |
| | | | Extraction | |
| Print-on | Spin-on | UV | Supercritical | Liquid |
| | | | Extraction | |
| Print-on | Spin-on | UV | Supercritical | Supercritical |
| | | | Extraction | |
| Print-on | Spin-on | UV | UV | Vapor |
| Print-on | Spin-on | UV | UV | Liquid |
| Print-on | Spin-on | UV | UV | Supercritical |
| Print-on | Spin-on | Electron beam | Thermal | Vapor |
| Print-on | Spin-on | Electron beam | Thermal | Liquid |
| Print-on | Spin-on | Electron beam | Thermal | Supercritical |
| Print-on | Spin-on | Electron beam | Plasma | Vapor |
| Print-on | Spin-on | Electron beam | Plasma | Liquid |
| Print-on | Spin-on | Electron beam | Plasma | Supercritical |
| Print-on | Spin-on | Electron beam | Supercritical | Vapor |
| | | | Extraction | |
| Print-on | Spin-on | Electron beam | Supercritical | Liquid |
| | | | Extraction | |
| Print-on | Spin-on | Electron beam | Supercritical | Supercritical |
| | | | Extraction | |
| Print-on | Spin-on | Electron beam | UV | Vapor |
| Print-on | Spin-on | Electron beam | UV | Liquid |
| Print-on | Spin-on | Electron beam | UV | Supercritical |
| Print-on | Print-on | Thermal | Thermal | Vapor |
| Print-on | Print-on | Thermal | Thermal | Liquid |
| Print-on | Print-on | Thermal | Thermal | Supercritical |
| Print-on | Print-on | Thermal | Plasma | Vapor |
| Print-on | Print-on | Thermal | Plasma | Liquid |
| Print-on | Print-on | Thermal | Plasma | Supercritical |
| Print-on | Print-on | Thermal | Supercritical | Vapor |
| | | | Extraction | |
| Print-on | Print-on | Thermal | Supercritical | Liquid |
| | | | Extraction | |
| Print-on | Print-on | Thermal | Supercritical | Supercritical |
| | | | Extraction | |
| Print-on | Print-on | Thermal | UV | Vapor |
| Print-on | Print-on | Thermal | UV | Liquid |
| Print-on | Print-on | Thermal | UV | Supercritical |
| Print-on | Print-on | Plasma | Thermal | Vapor |
| Print-on | Print-on | Plasma | Thermal | Liquid |
| Print-on | Print-on | Plasma | Thermal | Supercritical |
| Print-on | Print-on | Plasma | Plasma | Vapor |
| Print-on | Print-on | Plasma | Plasma | Liquid |
| Print-on | Print-on | Plasma | Plasma | Supercritical |
| Print-on | Print-on | Plasma | Supercritical | Vapor |
| | | | Extraction | |
| Print-on | Print-on | Plasma | Supercritical | Liquid |
| | | | Extraction | |
| Print-on | Print-on | Plasma | Supercritical | Supercritical |
| | | | Extraction | |
| Print-on | Print-on | Plasma | UV | Vapor |
| Print-on | Print-on | Plasma | UV | Liquid |
| Print-on | Print-on | Plasma | UV | Supercritical |
| Print-on | Print-on | UV | Thermal | Vapor |
| Print-on | Print-on | UV | Thermal | Liquid |
| Print-on | Print-on | UV | Thermal | Supercritical |
| Print-on | Print-on | UV | Plasma | Vapor |
| Print-on | Print-on | UV | Plasma | Liquid |
| Print-on | Print-on | UV | Plasma | Supercritical |
| Print-on | Print-on | UV | Supercritical | Vapor |
| | | | Extraction | |
| Print-on | Print-on | UV | Supercritical | Liquid |
| | | | Extraction | |
| Print-on | Print-on | UV | Supercritical | Supercritical |
| | | | Extraction | |
| Print-on | Print-on | UV | UV | Vapor |
| Print-on | Print-on | UV | UV | Liquid |
| Print-on | Print-on | UV | UV | Supercritical |
| Print-on | Print-on | Electron beam | Thermal | Vapor |
| Print-on | Print-on | Electron beam | Thermal | Liquid |
| Print-on | Print-on | Electron beam | Thermal | Supercritical |
| Print-on | Print-on | Electron beam | Plasma | Vapor |
| Print-on | Print-on | Electron beam | Plasma | Liquid |
| Print-on | Print-on | Electron beam | Plasma | Supercritical |
| Print-on | Print-on | Electron beam | Supercritical | Vapor |
| | | | Extraction | |
| Print-on | Print-on | Electron beam | Supercritical | Liquid |
| | | | Extraction | |
| Print-on | Print-on | Electron beam | Supercritical | Supercritical |
| | | | Extraction | |
| Print-on | Print-on | Electron beam | UV | Vapor |
| Print-on | Print-on | Electron beam | UV | Liquid |
| Print-on | Print-on | Electron beam | UV | Supercritical |
| Print-on | Supercritical Infusion | Thermal | Thermal | Vapor |
| Print-on | Supercritical Infusion | Thermal | Thermal | Liquid |
| Print-on | Supercritical Infusion | Thermal | Thermal | Supercritical |
| Print-on | Supercritical Infusion | Thermal | Plasma | Vapor |
| Print-on | Supercritical Infusion | Thermal | Plasma | Liquid |
| Print-on | Supercritical Infusion | Thermal | Plasma | Supercritical |
| Print-on | Supercritical Infusion | Thermal | Supercritical | Vapor |
| | | | Extraction | |
| Print-on | Supercritical Infusion | Thermal | Supercritical | Liquid |
| | | | Extraction | |
| Print-on | Supercritical Infusion | Thermal | Supercritical | Supercritical |
| | | | Extraction | |
| Print-on | Supercritical Infusion | Thermal | UV | Vapor |
| Print-on | Supercritical Infusion | Thermal | UV | Liquid |
| Print-on | Supercritical Infusion | Thermal | UV | Supercritical |
| Print-on | Supercritical Infusion | Plasma | Thermal | Vapor |
| Print-on | Supercritical Infusion | Plasma | Thermal | Liquid |
| Print-on | Supercritical Infusion | Plasma | Thermal | Supercritical |
| Print-on | Supercritical Infusion | Plasma | Plasma | Vapor |
| Print-on | Supercritical Infusion | Plasma | Plasma | Liquid |
| Print-on | Supercritical Infusion | Plasma | Plasma | Supercritical |
| Print-on | Supercritical Infusion | Plasma | Supercritical | Vapor |
| | | | Extraction | |
| Print-on | Supercritical Infusion | Plasma | Supercritical | Liquid |
| | | | Extraction | |
| Print-on | Supercritical Infusion | Plasma | Supercritical | Supercritical |
| | | | Extraction | |
| Print-on | Supercritical Infusion | Plasma | UV | Vapor |
| Print-on | Supercritical Infusion | Plasma | UV | Liquid |
| Print-on | Supercritical Infusion | Plasma | UV | Supercritical |
| Print-on | Supercritical Infusion | UV | Thermal | Vapor |
| Print-on | Supercritical Infusion | UV | Thermal | Liquid |
| Print-on | Supercritical Infusion | UV | Thermal | Supercritical |
| Print-on | Supercritical Infusion | UV | Plasma | Vapor |
| Print-on | Supercritical Infusion | UV | Plasma | Liquid |
| Print-on | Supercritical Infusion | UV | Plasma | Supercritical |
| Print-on | Supercritical Infusion | UV | Supercritical | Vapor |
| | | | Extraction | |
| Print-on | Supercritical Infusion | UV | Supercritical | Liquid |
| | | | Extraction | |
| Print-on | Supercritical Infusion | UV | Supercritical | Supercritical |
| | | | Extraction | |
| Print-on | Supercritical Infusion | UV | UV | Vapor |
| Print-on | Supercritical Infusion | UV | UV | Liquid |
| Print-on | Supercritical Infusion | UV | UV | Supercritical |
| Print-on | Supercritical Infusion | Electron beam | Thermal | Vapor |
| Print-on | Supercritical Infusion | Electron beam | Thermal | Liquid |
| Print-on | Supercritical Infusion | Electron beam | Thermal | Supercritical |
| Print-on | Supercritical Infusion | Electron beam | Plasma | Vapor |
| Print-on | Supercritical Infusion | Electron beam | Plasma | Liquid |
| Print-on | Supercritical Infusion | Electron beam | Plasma | Supercritical |
| Print-on | Supercritical Infusion | Electron beam | Supercritical | Vapor |
| | | | Extraction | |
| Print-on | Supercritical Infusion | Electron beam | Supercritical | Liquid |
| | | | Extraction | |
| Print-on | Supercritical Infusion | Electron beam | Supercritical | Supercritical |
| | | | Extraction | |
| Print-on | Supercritical Infusion | Electron beam | UV | Vapor |
| Print-on | Supercritical Infusion | Electron beam | UV | Liquid |
| Print-on | Supercritical Infusion | Electron beam | UV | Supercritical |
| Print-on | Liquid Immersion | Thermal | Thermal | Vapor |
| Print-on | Liquid Immersion | Thermal | Thermal | Liquid |
| Print-on | Liquid Immersion | Thermal | Thermal | Supercritical |
| Print-on | Liquid Immersion | Thermal | Plasma | Vapor |
| Print-on | Liquid Immersion | Thermal | Plasma | Liquid |
| Print-on | Liquid Immersion | Thermal | Plasma | Supercritical |
| Print-on | Liquid Immersion | Thermal | Supercritical | Vapor |
| | | | Extraction | |
| Print-on | Liquid Immersion | Thermal | Supercritical | Liquid |
| | | | Extraction | |
| Print-on | Liquid Immersion | Thermal | Supercritical | Supercritical |
| | | | Extraction | |
| Print-on | Liquid Immersion | Thermal | UV | Vapor |
| Print-on | Liquid Immersion | Thermal | UV | Liquid |
| Print-on | Liquid Immersion | Thermal | UV | Supercritical |
| Print-on | Liquid Immersion | Plasma | Thermal | Vapor |
| Print-on | Liquid Immersion | Plasma | Thermal | Liquid |
| Print-on | Liquid Immersion | Plasma | Thermal | Supercritical |
| Print-on | Liquid Immersion | Plasma | Plasma | Vapor |
| Print-on | Liquid Immersion | Plasma | Plasma | Liquid |
| Print-on | Liquid Immersion | Plasma | Plasma | Supercritical |
| Print-on | Liquid Immersion | Plasma | Supercritical | Vapor |
| | | | Extraction | |
| Print-on | Liquid Immersion | Plasma | Supercritical | Liquid |
| | | | Extraction | |
| Print-on | Liquid Immersion | Plasma | Supercritical | Supercritical |
| | | | Extraction | |
| Print-on | Liquid Immersion | Plasma | UV | Vapor |
| Print-on | Liquid Immersion | Plasma | UV | Liquid |
| Print-on | Liquid Immersion | Plasma | UV | Supercritical |
| Print-on | Liquid Immersion | UV | Thermal | Vapor |
| Print-on | Liquid Immersion | UV | Thermal | Liquid |
| Print-on | Liquid Immersion | UV | Thermal | Supercritical |
| Print-on | Liquid Immersion | UV | Plasma | Vapor |
| Print-on | Liquid Immersion | UV | Plasma | Liquid |
| Print-on | Liquid Immersion | UV | Plasma | Supercritical |
| Print-on | Liquid Immersion | UV | Supercritical | Vapor |
| | | | Extraction | |
| Print-on | Liquid Immersion | UV | Supercritical | Liquid |
| | | | Extraction | |
| Print-on | Liquid Immersion | UV | Supercritical | Supercritical |
| | | | Extraction | |
| Print-on | Liquid Immersion | UV | UV | Vapor |
| Print-on | Liquid Immersion | UV | UV | Liquid |
| Print-on | Liquid Immersion | UV | UV | Supercritical |
| Print-on | Liquid Immersion | Electron beam | Thermal | Vapor |
| Print-on | Liquid Immersion | Electron beam | Thermal | Liquid |
| Print-on | Liquid Immersion | Electron beam | Thermal | Supercritical |
| Print-on | Liquid Immersion | Electron beam | Plasma | Vapor |
| Print-on | Liquid Immersion | Electron beam | Plasma | Liquid |
| Print-on | Liquid Immersion | Electron beam | Plasma | Supercritical |
| Print-on | Liquid Immersion | Electron beam | Supercritical | Vapor |
| | | | Extraction | |
| Print-on | Liquid Immersion | Electron beam | Supercritical | Liquid |
| | | | Extraction | |
| Print-on | Liquid Immersion | Electron beam | Supercritical | Supercritical |
| | | | Extraction | |
| Print-on | Liquid Immersion | Electron beam | UV | Vapor |
| Print-on | Liquid Immersion | Electron beam | UV | Liquid |
| Print-on | Liquid Immersion | Electron beam | UV | Supercritical |
| Print-on | CVD | Thermal | Thermal | Vapor |
| Print-on | CVD | Thermal | Thermal | Liquid |
| Print-on | CVD | Thermal | Thermal | Supercritical |
| Print-on | CVD | Thermal | Plasma | Vapor |
| Print-on | CVD | Thermal | Plasma | Liquid |
| Print-on | CVD | Thermal | Plasma | Supercritical |
| Print-on | CVD | Thermal | Supercritical | Vapor |
| | | | Extraction | |
| Print-on | CVD | Thermal | Supercritical | Liquid |
| | | | Extraction | |
| Print-on | CVD | Thermal | Supercritical | Supercritical |
| | | | Extraction | |
| Print-on | CVD | Thermal | UV | Vapor |
| Print-on | CVD | Thermal | UV | Liquid |
| Print-on | CVD | Thermal | UV | Supercritical |
| Print-on | CVD | Plasma | Thermal | Vapor |
| Print-on | CVD | Plasma | Thermal | Liquid |
| Print-on | CVD | Plasma | Thermal | Supercritical |
| Print-on | CVD | Plasma | Plasma | Vapor |
| Print-on | CVD | Plasma | Plasma | Liquid |
| Print-on | CVD | Plasma | Plasma | Supercritical |
| Print-on | CVD | Plasma | Supercritical | Vapor |
| | | | Extraction | |
| Print-on | CVD | Plasma | Supercritical | Liquid |
| | | | Extraction | |
| Print-on | CVD | Plasma | Supercritical | Supercritical |
| | | | Extraction | |
| Print-on | CVD | Plasma | UV | Vapor |
| Print-on | CVD | Plasma | UV | Liquid |
| Print-on | CVD | Plasma | UV | Supercritical |
| Print-on | CVD | UV | Thermal | Vapor |
| Print-on | CVD | UV | Thermal | Liquid |
| Print-on | CVD | UV | Thermal | Supercritical |
| Print-on | CVD | UV | Plasma | Vapor |
| Print-on | CVD | UV | Plasma | Liquid |
| Print-on | CVD | UV | Plasma | Supercritical |
| Print-on | CVD | UV | Supercritical | Vapor |
| | | | Extraction | |
| Print-on | CVD | UV | Supercritical | Liquid |
| | | | Extraction | |
| Print-on | CVD | UV | Supercritical | Supercritical |
| | | | Extraction | |
| Print-on | CVD | UV | UV | Vapor |
| Print-on | CVD | UV | UV | Liquid |
| Print-on | CVD | UV | UV | Supercritical |
| Print-on | CVD | Electron beam | Thermal | Vapor |
| Print-on | CVD | Electron beam | Thermal | Liquid |
| Print-on | CVD | Electron beam | Thermal | Supercritical |
| Print-on | CVD | Electron beam | Plasma | Vapor |
| Print-on | CVD | Electron beam | Plasma | Liquid |
| Print-on | CVD | Electron beam | Plasma | Supercritical |
| Print-on | CVD | Electron beam | Supercritical | Vapor |
| | | | Extraction | |
| Print-on | CVD | Electron beam | Supercritical | Liquid |
| | | | Extraction | |
| Print-on | CVD | Electron beam | Supercritical | Supercritical |
| | | | Extraction | |
| Print-on | CVD | Electron beam | UV | Vapor |
| Print-on | CVD | Electron beam | UV | Liquid |
| Print-on | CVD | Electron beam | UV | Supercritical |
| CVD | Spin-on | Thermal | Thermal | Vapor |
| CVD | Spin-on | Thermal | Thermal | Liquid |
| CVD | Spin-on | Thermal | Thermal | Supercritical |
| CVD | Spin-on | Thermal | Plasma | Vapor |
| CVD | Spin-on | Thermal | Plasma | Liquid |
| CVD | Spin-on | Thermal | Plasma | Supercritical |
| CVD | Spin-on | Thermal | Supercritical | Vapor |
| | | | Extraction | |
| CVD | Spin-on | Thermal | Supercritical | Liquid |
| | | | Extraction | |
| CVD | Spin-on | Thermal | Supercritical | Supercritical |
| | | | Extraction | |
| CVD | Spin-on | Thermal | UV | Vapor |
| CVD | Spin-on | Thermal | UV | Liquid |
| CVD | Spin-on | Thermal | UV | Supercritical |
| CVD | Spin-on | Plasma | Thermal | Vapor |
| CVD | Spin-on | Plasma | Thermal | Liquid |
| CVD | Spin-on | Plasma | Thermal | Supercritical |
| CVD | Spin-on | Plasma | Plasma | Vapor |
| CVD | Spin-on | Plasma | Plasma | Liquid |
| CVD | Spin-on | Plasma | Plasma | Supercritical |
| CVD | Spin-on | Plasma | Supercritical | Vapor |
| | | | Extraction | |
| CVD | Spin-on | Plasma | Supercritical | Liquid |
| | | | Extraction | |
| CVD | Spin-on | Plasma | Supercritical | Supercritical |
| | | | Extraction | |
| CVD | Spin-on | Plasma | UV | Vapor |
| CVD | Spin-on | Plasma | UV | Liquid |
| CVD | Spin-on | Plasma | UV | Supercritical |
| CVD | Spin-on | UV | Thermal | Vapor |
| CVD | Spin-on | UV | Thermal | Liquid |
| CVD | Spin-on | UV | Thermal | Supercritical |
| CVD | Spin-on | UV | Plasma | Vapor |
| CVD | Spin-on | UV | Plasma | Liquid |
| CVD | Spin-on | UV | Plasma | Supercritical |
| CVD | Spin-on | UV | Supercritical | Vapor |
| | | | Extraction | |
| CVD | Spin-on | UV | Supercritical | Liquid |
| | | | Extraction | |
| CVD | Spin-on | UV | Supercritical | Supercritical |
| | | | Extraction | |
| CVD | Spin-on | UV | UV | Vapor |
| CVD | Spin-on | UV | UV | Liquid |
| CVD | Spin-on | UV | UV | Supercritical |
| CVD | Spin-on | Electron beam | Thermal | Vapor |
| CVD | Spin-on | Electron beam | Thermal | Liquid |
| CVD | Spin-on | Electron beam | Thermal | Supercritical |
| CVD | Spin-on | Electron beam | Plasma | Vapor |
| CVD | Spin-on | Electron beam | Plasma | Liquid |
| CVD | Spin-on | Electron beam | Plasma | Supercritical |
| CVD | Spin-on | Electron beam | Supercritical | Vapor |
| | | | Extraction | |
| CVD | Spin-on | Electron beam | Supercritical | Liquid |
| | | | Extraction | |
| CVD | Spin-on | Electron beam | Supercritical | Supercritical |
| | | | Extraction | |
| CVD | Spin-on | Electron beam | UV | Vapor |
| CVD | Spin-on | Electron beam | UV | Liquid |
| CVD | Spin-on | Electron beam | UV | Supercritical |
| CVD | Print-on | Thermal | Thermal | Vapor |
| CVD | Print-on | Thermal | Thermal | Liquid |
| CVD | Print-on | Thermal | Thermal | Supercritical |
| CVD | Print-on | Thermal | Plasma | Vapor |
| CVD | Print-on | Thermal | Plasma | Liquid |
| CVD | Print-on | Thermal | Plasma | Supercritical |
| CVD | Print-on | Thermal | Supercritical | Vapor |
| | | | Extraction | |
| CVD | Print-on | Thermal | Supercritical | Liquid |
| | | | Extraction | |
| CVD | Print-on | Thermal | Supercritical | Supercritical |
| | | | Extraction | |
| CVD | Print-on | Thermal | UV | Vapor |
| CVD | Print-on | Thermal | UV | Liquid |
| CVD | Print-on | Thermal | UV | Supercritical |
| CVD | Print-on | Plasma | Thermal | Vapor |
| CVD | Print-on | Plasma | Thermal | Liquid |
| CVD | Print-on | Plasma | Thermal | Supercritical |
| CVD | Print-on | Plasma | Plasma | Vapor |
| CVD | Print-on | Plasma | Plasma | Liquid |
| CVD | Print-on | Plasma | Plasma | Supercritical |
| CVD | Print-on | Plasma | Supercritical | Vapor |
| | | | Extraction | |
| CVD | Print-on | Plasma | Supercritical | Liquid |
| | | | Extraction | |
| CVD | Print-on | Plasma | Supercritical | Supercritical |
| | | | Extraction | |
| CVD | Print-on | Plasma | UV | Vapor |
| CVD | Print-on | Plasma | UV | Liquid |
| CVD | Print-on | Plasma | UV | Supercritical |
| CVD | Print-on | UV | Thermal | Vapor |
| CVD | Print-on | UV | Thermal | Liquid |
| CVD | Print-on | UV | Thermal | Supercritical |
| CVD | Print-on | UV | Plasma | Vapor |
| CVD | Print-on | UV | Plasma | Liquid |
| CVD | Print-on | UV | Plasma | Supercritical |
| CVD | Print-on | UV | Supercritical | Vapor |
| | | | Extraction | |
| CVD | Print-on | UV | Supercritical | Liquid |
| | | | Extraction | |
| CVD | Print-on | UV | Supercritical | Supercritical |
| | | | Extraction | |
| CVD | Print-on | UV | UV | Vapor |
| CVD | Print-on | UV | UV | Liquid |
| CVD | Print-on | UV | UV | Supercritical |
| CVD | Print-on | Electron beam | Thermal | Vapor |
| CVD | Print-on | Electron beam | Thermal | Liquid |
| CVD | Print-on | Electron beam | Thermal | Supercritical |
| CVD | Print-on | Electron beam | Plasma | Vapor |
| CVD | Print-on | Electron beam | Plasma | Liquid |
| CVD | Print-on | Electron beam | Plasma | Supercritical |
| CVD | Print-on | Electron beam | Supercritical | Vapor |
| | | | Extraction | |
| CVD | Print-on | Electron beam | Supercritical | Liquid |
| | | | Extraction | |
| CVD | Print-on | Electron beam | Supercritical | Supercritical |
| | | | Extraction | |
| CVD | Print-on | Electron beam | UV | Vapor |
| CVD | Print-on | Electron beam | UV | Liquid |
| CVD | Print-on | Electron beam | UV | Supercritical |
| CVD | Supercritical Infusion | Thermal | Thermal | Vapor |
| CVD | Supercritical Infusion | Thermal | Thermal | Liquid |
| CVD | Supercritical Infusion | Thermal | Thermal | Supercritical |
| CVD | Supercritical Infusion | Thermal | Plasma | Vapor |
| CVD | Supercritical Infusion | Thermal | Plasma | Liquid |
| CVD | Supercritical Infusion | Thermal | Plasma | Supercritical |
| CVD | Supercritical Infusion | Thermal | Supercritical | Vapor |
| | | | Extraction | |
| CVD | Supercritical Infusion | Thermal | Supercritical | Liquid |
| | | | Extraction | |
| CVD | Supercritical Infusion | Thermal | Supercritical | Supercritical |
| | | | Extraction | |
| CVD | Supercritical Infusion | Thermal | UV | Vapor |
| CVD | Supercritical Infusion | Thermal | UV | Liquid |
| CVD | Supercritical Infusion | Thermal | UV | Supercritical |
| CVD | Supercritical Infusion | Plasma | Thermal | Vapor |
| CVD | Supercritical Infusion | Plasma | Thermal | Liquid |
| CVD | Supercritical Infusion | Plasma | Thermal | Supercritical |
| CVD | Supercritical Infusion | Plasma | Plasma | Vapor |
| CVD | Supercritical Infusion | Plasma | Plasma | Liquid |
| CVD | Supercritical Infusion | Plasma | Plasma | Supercritical |
| CVD | Supercritical Infusion | Plasma | Supercritical | Vapor |
| | | | Extraction | |
| CVD | Supercritical Infusion | Plasma | Supercritical | Liquid |
| | | | Extraction | |
| CVD | Supercritical Infusion | Plasma | Supercritical | Supercritical |
| | | | Extraction | |
| CVD | Supercritical Infusion | Plasma | UV | Vapor |
| CVD | Supercritical Infusion | Plasma | UV | Liquid |
| CVD | Supercritical Infusion | Plasma | UV | Supercritical |
| CVD | Supercritical Infusion | UV | Thermal | Vapor |
| CVD | Supercritical Infusion | UV | Thermal | Liquid |
| CVD | Supercritical Infusion | UV | Thermal | Supercritical |
| CVD | Supercritical Infusion | UV | Plasma | Vapor |
| CVD | Supercritical Infusion | UV | Plasma | Liquid |
| CVD | Supercritical Infusion | UV | Plasma | Supercritical |
| CVD | Supercritical Infusion | UV | Supercritical | Vapor |
| | | | Extraction | |
| CVD | Supercritical Infusion | UV | Supercritical | Liquid |
| | | | Extraction | |
| CVD | Supercritical Infusion | UV | Supercritical | Supercritical |
| | | | Extraction | |
| CVD | Supercritical Infusion | UV | UV | Vapor |
| CVD | Supercritical Infusion | UV | UV | Liquid |
| CVD | Supercritical Infusion | UV | UV | Supercritical |
| CVD | Supercritical Infusion | Electron beam | Thermal | Vapor |
| CVD | Supercritical Infusion | Electron beam | Thermal | Liquid |
| CVD | Supercritical Infusion | Electron beam | Thermal | Supercritical |
| CVD | Supercritical Infusion | Electron beam | Plasma | Vapor |
| CVD | Supercritical Infusion | Electron beam | Plasma | Liquid |
| CVD | Supercritical Infusion | Electron beam | Plasma | Supercritical |
| CVD | Supercritical Infusion | Electron beam | Supercritical | Vapor |
| | | | Extraction | |
| CVD | Supercritical Infusion | Electron beam | Supercritical | Liquid |
| | | | Extraction | |
| CVD | Supercritical Infusion | Electron beam | Supercritical | Supercritical |
| | | | Extraction | |
| CVD | Supercritical Infusion | Electron beam | UV | Vapor |
| CVD | Supercritical Infusion | Electron beam | UV | Liquid |
| CVD | Supercritical Infusion | Electron beam | UV | Supercritical |
| CVD | Liquid Immersion | Thermal | Thermal | Vapor |
| CVD | Liquid Immersion | Thermal | Thermal | Liquid |
| CVD | Liquid Immersion | Thermal | Thermal | Supercritical |
| CVD | Liquid Immersion | Thermal | Plasma | Vapor |
| CVD | Liquid Immersion | Thermal | Plasma | Liquid |
| CVD | Liquid Immersion | Thermal | Plasma | Supercritical |
| CVD | Liquid Immersion | Thermal | Supercritical | Vapor |
| | | | Extraction | |
| CVD | Liquid Immersion | Thermal | Supercritical | Liquid |
| | | | Extraction | |
| CVD | Liquid Immersion | Thermal | Supercritical | Supercritical |
| | | | Extraction | |
| CVD | Liquid Immersion | Thermal | UV | Vapor |
| CVD | Liquid Immersion | Thermal | UV | Liquid |
| CVD | Liquid Immersion | Thermal | UV | Supercritical |
| CVD | Liquid Immersion | Plasma | Thermal | Vapor |
| CVD | Liquid Immersion | Plasma | Thermal | Liquid |
| CVD | Liquid Immersion | Plasma | Thermal | Supercritical |
| CVD | Liquid Immersion | Plasma | Plasma | Vapor |
| CVD | Liquid Immersion | Plasma | Plasma | Liquid |
| CVD | Liquid Immersion | Plasma | Plasma | Supercritical |
| CVD | Liquid Immersion | Plasma | Supercritical | Vapor |
| | | | Extraction | |
| CVD | Liquid Immersion | Plasma | Supercritical | Liquid |
| | | | Extraction | |
| CVD | Liquid Immersion | Plasma | Supercritical | Supercritical |
| | | | Extraction | |
| CVD | Liquid Immersion | Plasma | UV | Vapor |
| CVD | Liquid Immersion | Plasma | UV | Liquid |
| CVD | Liquid Immersion | Plasma | UV | Supercritical |
| CVD | Liquid Immersion | UV | Thermal | Vapor |
| CVD | Liquid Immersion | UV | Thermal | Liquid |
| CVD | Liquid Immersion | UV | Thermal | Supercritical |
| CVD | Liquid Immersion | UV | Plasma | Vapor |
| CVD | Liquid Immersion | UV | Plasma | Liquid |
| CVD | Liquid Immersion | UV | Plasma | Supercritical |
| CVD | Liquid Immersion | UV | Supercritical | Vapor |
| | | | Extraction | |
| CVD | Liquid Immersion | UV | Supercritical | Liquid |
| | | | Extraction | |
| CVD | Liquid Immersion | UV | Supercritical | Supercritical |
| | | | Extraction | |
| CVD | Liquid Immersion | UV | UV | Vapor |
| CVD | Liquid Immersion | UV | UV | Liquid |
| CVD | Liquid Immersion | UV | UV | Supercritical |
| CVD | Liquid Immersion | Electron beam | Thermal | Vapor |
| CVD | Liquid Immersion | Electron beam | Thermal | Liquid |
| CVD | Liquid Immersion | Electron beam | Thermal | Supercritical |
| CVD | Liquid Immersion | Electron beam | Plasma | Vapor |
| CVD | Liquid Immersion | Electron beam | Plasma | Liquid |
| CVD | Liquid Immersion | Electron beam | Plasma | Supercritical |
| CVD | Liquid Immersion | Electron beam | Supercritical | Vapor |
| | | | Extraction | |
| CVD | Liquid Immersion | Electron beam | Supercritical | Liquid |
| | | | Extraction | |
| CVD | Liquid Immersion | Electron beam | Supercritical | Supercritical |
| | | | Extraction | |
| CVD | Liquid Immersion | Electron beam | UV | Vapor |
| CVD | Liquid Immersion | Electron beam | UV | Liquid |
| CVD | Liquid Immersion | Electron beam | UV | Supercritical |
| CVD | CVD | Thermal | Thermal | Vapor |
| CVD | CVD | Thermal | Thermal | Liquid |
| CVD | CVD | Thermal | Thermal | Supercritical |
| CVD | CVD | Thermal | Plasma | Vapor |
| CVD | CVD | Thermal | Plasma | Liquid |
| CVD | CVD | Thermal | Plasma | Supercritical |
| CVD | CVD | Thermal | Supercritical | Vapor |
| | | | Extraction | |
| CVD | CVD | Thermal | Supercritical | Liquid |
| | | | Extraction | |
| CVD | CVD | Thermal | Supercritical | Supercritical |
| | | | Extraction | |
| CVD | CVD | Thermal | UV | Vapor |
| CVD | CVD | Thermal | UV | Liquid |
| CVD | CVD | Thermal | UV | Supercritical |
| CVD | CVD | Plasma | Thermal | Vapor |
| CVD | CVD | Plasma | Thermal | Liquid |
| CVD | CVD | Plasma | Thermal | Supercritical |
| CVD | CVD | Plasma | Plasma | Vapor |
| CVD | CVD | Plasma | Plasma | Liquid |
| CVD | CVD | Plasma | Plasma | Supercritical |
| CVD | CVD | Plasma | Supercritical | Vapor |
| | | | Extraction | |
| CVD | CVD | Plasma | Supercritical | Liquid |
| | | | Extraction | |
| CVD | CVD | Plasma | Supercritical | Supercritical |
| | | | Extraction | |
| CVD | CVD | Plasma | UV | Vapor |
| CVD | CVD | Plasma | UV | Liquid |
| CVD | CVD | Plasma | UV | Supercritical |
| CVD | CVD | UV | Thermal | Vapor |
| CVD | CVD | UV | Thermal | Liquid |
| CVD | CVD | UV | Thermal | Supercritical |
| CVD | CVD | UV | Plasma | Vapor |
| CVD | CVD | UV | Plasma | Liquid |
| CVD | CVD | UV | Plasma | Supercritical |
| CVD | CVD | UV | Supercritical | Vapor |
| | | | Extraction | |
| CVD | CVD | UV | Supercritical | Liquid |
| | | | Extraction | |
| CVD | CVD | UV | Supercritical | Supercritical |
| | | | Extraction | |
| CVD | CVD | UV | UV | Vapor |
| CVD | CVD | UV | UV | Liquid |
| CVD | CVD | UV | UV | Supercritical |
| CVD | CVD | Electron beam | Thermal | Vapor |
| CVD | CVD | Electron beam | Thermal | Liquid |
| CVD | CVD | Electron beam | Thermal | Supercritical |
| CVD | CVD | Electron beam | Plasma | Vapor |
| CVD | CVD | Electron beam | Plasma | Liquid |
| CVD | CVD | Electron beam | Plasma | Supercritical |
| CVD | CVD | Electron beam | Supercritical | Vapor |
| | | | Extraction | |
| CVD | CVD | Electron beam | Supercritical | Liquid |
| | | | Extraction | |
| CVD | CVD | Electron beam | Supercritical | Supercritical |
| | | | Extraction | |
| CVD | CVD | Electron beam | UV | Vapor |
| CVD | CVD | Electron beam | UV | Liquid |
| CVD | CVD | Electron beam | UV | Supercritical |
| Evaporation | Spin-on | Thermal | Thermal | Vapor |
| Evaporation | Spin-on | Thermal | Thermal | Liquid |
| Evaporation | Spin-on | Thermal | Thermal | Supercritical |
| Evaporation | Spin-on | Thermal | Plasma | Vapor |
| Evaporation | Spin-on | Thermal | Plasma | Liquid |
| Evaporation | Spin-on | Thermal | Plasma | Supercritical |
| Evaporation | Spin-on | Thermal | Supercritical | Vapor |
| | | | Extraction | |
| Evaporation | Spin-on | Thermal | Supercritical | Liquid |
| | | | Extraction | |
| Evaporation | Spin-on | Thermal | Supercritical | Supercritical |
| | | | Extraction | |
| Evaporation | Spin-on | Thermal | UV | Vapor |
| Evaporation | Spin-on | Thermal | UV | Liquid |
| Evaporation | Spin-on | Thermal | UV | Supercritical |
| Evaporation | Spin-on | Plasma | Thermal | Vapor |
| Evaporation | Spin-on | Plasma | Thermal | Liquid |
| Evaporation | Spin-on | Plasma | Thermal | Supercritical |
| Evaporation | Spin-on | Plasma | Plasma | Vapor |
| Evaporation | Spin-on | Plasma | Plasma | Liquid |
| Evaporation | Spin-on | Plasma | Plasma | Supercritical |
| Evaporation | Spin-on | Plasma | Supercritical | Vapor |
| | | | Extraction | |
| Evaporation | Spin-on | Plasma | Supercritical | Liquid |
| | | | Extraction | |
| Evaporation | Spin-on | Plasma | Supercritical | Supercritical |
| | | | Extraction | |
| Evaporation | Spin-on | Plasma | UV | Vapor |
| Evaporation | Spin-on | Plasma | UV | Liquid |
| Evaporation | Spin-on | Plasma | UV | Supercritical |
| Evaporation | Spin-on | UV | Thermal | Vapor |
| Evaporation | Spin-on | UV | Thermal | Liquid |
| Evaporation | Spin-on | UV | Thermal | Supercritical |
| Evaporation | Spin-on | UV | Plasma | Vapor |
| Evaporation | Spin-on | UV | Plasma | Liquid |
| Evaporation | Spin-on | UV | Plasma | Supercritical |
| Evaporation | Spin-on | UV | Supercritical | Vapor |
| | | | Extraction | |
| Evaporation | Spin-on | UV | Supercritical | Liquid |
| | | | Extraction | |
| Evaporation | Spin-on | UV | Supercritical | Supercritical |
| | | | Extraction | |
| Evaporation | Spin-on | UV | UV | Vapor |
| Evaporation | Spin-on | UV | UV | Liquid |
| Evaporation | Spin-on | UV | UV | Supercritical |
| Evaporation | Spin-on | Electron beam | Thermal | Vapor |
| Evaporation | Spin-on | Electron beam | Thermal | Liquid |
| Evaporation | Spin-on | Electron beam | Thermal | Supercritical |
| Evaporation | Spin-on | Electron beam | Plasma | Vapor |
| Evaporation | Spin-on | Electron beam | Plasma | Liquid |
| Evaporation | Spin-on | Electron beam | Plasma | Supercritical |
| Evaporation | Spin-on | Electron beam | Supercritical | Vapor |
| | | | Extraction | |
| Evaporation | Spin-on | Electron beam | Supercritical | Liquid |
| | | | Extraction | |
| Evaporation | Spin-on | Electron beam | Supercritical | Supercritical |
| | | | Extraction | |
| Evaporation | Spin-on | Electron beam | UV | Vapor |
| Evaporation | Spin-on | Electron beam | UV | Liquid |
| Evaporation | Spin-on | Electron beam | UV | Supercritical |
| Evaporation | Print-on | Thermal | Thermal | Vapor |
| Evaporation | Print-on | Thermal | Thermal | Liquid |
| Evaporation | Print-on | Thermal | Thermal | Supercritical |
| Evaporation | Print-on | Thermal | Plasma | Vapor |
| Evaporation | Print-on | Thermal | Plasma | Liquid |
| Evaporation | Print-on | Thermal | Plasma | Supercritical |
| Evaporation | Print-on | Thermal | Supercritical | Vapor |
| | | | Extraction | |
| Evaporation | Print-on | Thermal | Supercritical | Liquid |
| | | | Extraction | |
| Evaporation | Print-on | Thermal | Supercritical | Supercritical |
| | | | Extraction | |
| Evaporation | Print-on | Thermal | UV | Vapor |
| Evaporation | Print-on | Thermal | UV | Liquid |
| Evaporation | Print-on | Thermal | UV | Supercritical |
| Evaporation | Print-on | Plasma | Thermal | Vapor |
| Evaporation | Print-on | Plasma | Thermal | Liquid |
| Evaporation | Print-on | Plasma | Thermal | Supercritical |
| Evaporation | Print-on | Plasma | Plasma | Vapor |
| Evaporation | Print-on | Plasma | Plasma | Liquid |
| Evaporation | Print-on | Plasma | Plasma | Supercritical |
| Evaporation | Print-on | Plasma | Supercritical | Vapor |
| | | | Extraction | |
| Evaporation | Print-on | Plasma | Supercritical | Liquid |
| | | | Extraction | |
| Evaporation | Print-on | Plasma | Supercritical | Supercritical |
| | | | Extraction | |
| Evaporation | Print-on | Plasma | UV | Vapor |
| Evaporation | Print-on | Plasma | UV | Liquid |
| Evaporation | Print-on | Plasma | UV | Supercritical |
| Evaporation | Print-on | UV | Thermal | Vapor |
| Evaporation | Print-on | UV | Thermal | Liquid |
| Evaporation | Print-on | UV | Thermal | Supercritical |
| Evaporation | Print-on | UV | Plasma | Vapor |
| Evaporation | Print-on | UV | Plasma | Liquid |
| Evaporation | Print-on | UV | Plasma | Supercritical |
| Evaporation | Print-on | UV | Supercritical | Vapor |
| | | | Extraction | |
| Evaporation | Print-on | UV | Supercritical | Liquid |
| | | | Extraction | |
| Evaporation | Print-on | UV | Supercritical | Supercritical |
| | | | Extraction | |
| Evaporation | Print-on | UV | UV | Vapor |
| Evaporation | Print-on | UV | UV | Liquid |
| Evaporation | Print-on | UV | UV | Supercritical |
| Evaporation | Print-on | Electron beam | Thermal | Vapor |
| Evaporation | Print-on | Electron beam | Thermal | Liquid |
| Evaporation | Print-on | Electron beam | Thermal | Supercritical |
| Evaporation | Print-on | Electron beam | Plasma | Vapor |
| Evaporation | Print-on | Electron beam | Plasma | Liquid |
| Evaporation | Print-on | Electron beam | Plasma | Supercritical |
| Evaporation | Print-on | Electron beam | Supercritical | Vapor |
| | | | Extraction | |
| Evaporation | Print-on | Electron beam | Supercritical | Liquid |
| | | | Extraction | |
| Evaporation | Print-on | Electron beam | Supercritical | Supercritical |
| | | | Extraction | |
| Evaporation | Print-on | Electron beam | UV | Vapor |
| Evaporation | Print-on | Electron beam | UV | Liquid |
| Evaporation | Print-on | Electron beam | UV | Supercritical |
| Evaporation | Supercritical Infusion | Thermal | Thermal | Vapor |
| Evaporation | Supercritical Infusion | Thermal | Thermal | Liquid |
| Evaporation | Supercritical Infusion | Thermal | Thermal | Supercritical |
| Evaporation | Supercritical Infusion | Thermal | Plasma | Vapor |
| Evaporation | Supercritical Infusion | Thermal | Plasma | Liquid |
| Evaporation | Supercritical Infusion | Thermal | Plasma | Supercritical |
| Evaporation | Supercritical Infusion | Thermal | Supercritical | Vapor |
| | | | Extraction | |
| Evaporation | Supercritical Infusion | Thermal | Supercritical | Liquid |
| | | | Extraction | |
| Evaporation | Supercritical Infusion | Thermal | Supercritical | Supercritical |
| | | | Extraction | |
| Evaporation | Supercritical Infusion | Thermal | UV | Vapor |
| Evaporation | Supercritical Infusion | Thermal | UV | Liquid |
| Evaporation | Supercritical Infusion | Thermal | UV | Supercritical |
| Evaporation | Supercritical Infusion | Plasma | Thermal | Vapor |
| Evaporation | Supercritical Infusion | Plasma | Thermal | Liquid |
| Evaporation | Supercritical Infusion | Plasma | Thermal | Supercritical |
| Evaporation | Supercritical Infusion | Plasma | Plasma | Vapor |
| Evaporation | Supercritical Infusion | Plasma | Plasma | Liquid |
| Evaporation | Supercritical Infusion | Plasma | Plasma | Supercritical |
| Evaporation | Supercritical Infusion | Plasma | Supercritical | Vapor |
| | | | Extraction | |
| Evaporation | Supercritical Infusion | Plasma | Supercritical | Liquid |
| | | | Extraction | |
| Evaporation | Supercritical Infusion | Plasma | Supercritical | Supercritical |
| | | | Extraction | |
| Evaporation | Supercritical Infusion | Plasma | UV | Vapor |
| Evaporation | Supercritical Infusion | Plasma | UV | Liquid |
| Evaporation | Supercritical Infusion | Plasma | UV | Supercritical |
| Evaporation | Supercritical Infusion | UV | Thermal | Vapor |
| Evaporation | Supercritical Infusion | UV | Thermal | Liquid |
| Evaporation | Supercritical Infusion | UV | Thermal | Supercritical |
| Evaporation | Supercritical Infusion | UV | Plasma | Vapor |
| Evaporation | Supercritical Infusion | UV | Plasma | Liquid |
| Evaporation | Supercritical Infusion | UV | Plasma | Supercritical |
| Evaporation | Supercritical Infusion | UV | Supercritical | Vapor |
| | | | Extraction | |
| Evaporation | Supercritical Infusion | UV | Supercritical | Liquid |
| | | | Extraction | |
| Evaporation | Supercritical Infusion | UV | Supercritical | Supercritical |
| | | | Extraction | |
| Evaporation | Supercritical Infusion | UV | UV | Vapor |
| Evaporation | Supercritical Infusion | UV | UV | Liquid |
| Evaporation | Supercritical Infusion | UV | UV | Supercritical |
| Evaporation | Supercritical Infusion | Electron beam | Thermal | Vapor |
| Evaporation | Supercritical Infusion | Electron beam | Thermal | Liquid |
| Evaporation | Supercritical Infusion | Electron beam | Thermal | Supercritical |
| Evaporation | Supercritical Infusion | Electron beam | Plasma | Vapor |
| Evaporation | Supercritical Infusion | Electron beam | Plasma | Liquid |
| Evaporation | Supercritical Infusion | Electron beam | Plasma | Supercritical |
| Evaporation | Supercritical Infusion | Electron beam | Supercritical | Vapor |
| | | | Extraction | |
| Evaporation | Supercritical Infusion | Electron beam | Supercritical | Liquid |
| | | | Extraction | |
| Evaporation | Supercritical Infusion | Electron beam | Supercritical | Supercritical |
| | | | Extraction | |
| Evaporation | Supercritical Infusion | Electron beam | UV | Vapor |
| Evaporation | Supercritical Infusion | Electron beam | UV | Liquid |
| Evaporation | Supercritical Infusion | Electron beam | UV | Supercritical |
| Evaporation | Liquid Immersion | Thermal | Thermal | Vapor |
| Evaporation | Liquid Immersion | Thermal | Thermal | Liquid |
| Evaporation | Liquid Immersion | Thermal | Thermal | Supercritical |
| Evaporation | Liquid Immersion | Thermal | Plasma | Vapor |
| Evaporation | Liquid Immersion | Thermal | Plasma | Liquid |
| Evaporation | Liquid Immersion | Thermal | Plasma | Supercritical |
| Evaporation | Liquid Immersion | Thermal | Supercritical | Vapor |
| | | | Extraction | |
| Evaporation | Liquid Immersion | Thermal | Supercritical | Liquid |
| | | | Extraction | |
| Evaporation | Liquid Immersion | Thermal | Supercritical | Supercritical |
| | | | Extraction | |
| Evaporation | Liquid Immersion | Thermal | UV | Vapor |
| Evaporation | Liquid Immersion | Thermal | UV | Liquid |
| Evaporation | Liquid Immersion | Thermal | UV | Supercritical |
| Evaporation | Liquid Immersion | Plasma | Thermal | Vapor |
| Evaporation | Liquid Immersion | Plasma | Thermal | Liquid |
| Evaporation | Liquid Immersion | Plasma | Thermal | Supercritical |
| Evaporation | Liquid Immersion | Plasma | Plasma | Vapor |
| Evaporation | Liquid Immersion | Plasma | Plasma | Liquid |
| Evaporation | Liquid Immersion | Plasma | Plasma | Supercritical |
| Evaporation | Liquid Immersion | Plasma | Supercritical | Vapor |
| | | | Extraction | |
| Evaporation | Liquid Immersion | Plasma | Supercritical | Liquid |
| | | | Extraction | |
| Evaporation | Liquid Immersion | Plasma | Supercritical | Supercritical |
| | | | Extraction | |
| Evaporation | Liquid Immersion | Plasma | UV | Vapor |
| Evaporation | Liquid Immersion | Plasma | UV | Liquid |
| Evaporation | Liquid Immersion | Plasma | UV | Supercritical |
| Evaporation | Liquid Immersion | UV | Thermal | Vapor |
| Evaporation | Liquid Immersion | UV | Thermal | Liquid |
| Evaporation | Liquid Immersion | UV | Thermal | Supercritical |
| Evaporation | Liquid Immersion | UV | Plasma | Vapor |
| Evaporation | Liquid Immersion | UV | Plasma | Liquid |
| Evaporation | Liquid Immersion | UV | Plasma | Supercritical |
| Evaporation | Liquid Immersion | UV | Supercritical | Vapor |
| | | | Extraction | |
| Evaporation | Liquid Immersion | UV | Supercritical | Liquid |
| | | | Extraction | |
| Evaporation | Liquid Immersion | UV | Supercritical | Supercritical |
| | | | Extraction | |
| Evaporation | Liquid Immersion | UV | UV | Vapor |
| Evaporation | Liquid Immersion | UV | UV | Liquid |
| Evaporation | Liquid Immersion | UV | UV | Supercritical |
| Evaporation | Liquid Immersion | Electron beam | Thermal | Vapor |
| Evaporation | Liquid Immersion | Electron beam | Thermal | Liquid |
| Evaporation | Liquid Immersion | Electron beam | Thermal | Supercritical |
| Evaporation | Liquid Immersion | Electron beam | Plasma | Vapor |
| Evaporation | Liquid Immersion | Electron beam | Plasma | Liquid |
| Evaporation | Liquid Immersion | Electron beam | Plasma | Supercritical |
| Evaporation | Liquid Immersion | Electron beam | Supercritical | Vapor |
| | | | Extraction | |
| Evaporation | Liquid Immersion | Electron beam | Supercritical | Liquid |
| | | | Extraction | |
| Evaporation | Liquid Immersion | Electron beam | Supercritical | Supercritical |
| | | | Extraction | |
| Evaporation | Liquid Immersion | Electron beam | UV | Vapor |
| Evaporation | Liquid Immersion | Electron beam | UV | Liquid |
| Evaporation | Liquid Immersion | Electron beam | UV | Supercritical |
| Evaporation | CVD | Thermal | Thermal | Vapor |
| Evaporation | CVD | Thermal | Thermal | Liquid |
| Evaporation | CVD | Thermal | Thermal | Supercritical |
| Evaporation | CVD | Thermal | Plasma | Vapor |
| Evaporation | CVD | Thermal | Plasma | Liquid |
| Evaporation | CVD | Thermal | Plasma | Supercritical |
| Evaporation | CVD | Thermal | Supercritical | Vapor |
| | | | Extraction | |
| Evaporation | CVD | Thermal | Supercritical | Liquid |
| | | | Extraction | |
| Evaporation | CVD | Thermal | Supercritical | Supercritical |
| | | | Extraction | |
| Evaporation | CVD | Thermal | UV | Vapor |
| Evaporation | CVD | Thermal | UV | Liquid |
| Evaporation | CVD | Thermal | UV | Supercritical |
| Evaporation | CVD | Plasma | Thermal | Vapor |
| Evaporation | CVD | Plasma | Thermal | Liquid |
| Evaporation | CVD | Plasma | Thermal | Supercritical |
| Evaporation | CVD | Plasma | Plasma | Vapor |
| Evaporation | CVD | Plasma | Plasma | Liquid |
| Evaporation | CVD | Plasma | Plasma | Supercritical |
| Evaporation | CVD | Plasma | Supercritical | Vapor |
| | | | Extraction | |
| Evaporation | CVD | Plasma | Supercritical | Liquid |
| | | | Extraction | |
| Evaporation | CVD | Plasma | Supercritical | Supercritical |
| | | | Extraction | |
| Evaporation | CVD | Plasma | UV | Vapor |
| Evaporation | CVD | Plasma | UV | Liquid |
| Evaporation | CVD | Plasma | UV | Supercritical |
| Evaporation | CVD | UV | Thermal | Vapor |
| Evaporation | CVD | UV | Thermal | Liquid |
| Evaporation | CVD | UV | Thermal | Supercritical |
| Evaporation | CVD | UV | Plasma | Vapor |
| Evaporation | CVD | UV | Plasma | Liquid |
| Evaporation | CVD | UV | Plasma | Supercritical |
| Evaporation | CVD | UV | Supercritical | Vapor |
| | | | Extraction | |
| Evaporation | CVD | UV | Supercritical | Liquid |
| | | | Extraction | |
| Evaporation | CVD | UV | Supercritical | Supercritical |
| | | | Extraction | |
| Evaporation | CVD | UV | UV | Vapor |
| Evaporation | CVD | UV | UV | Liquid |
| Evaporation | CVD | UV | UV | Supercritical |
| Evaporation | CVD | Electron beam | Thermal | Vapor |
| Evaporation | CVD | Electron beam | Thermal | Liquid |
| Evaporation | CVD | Electron beam | Thermal | Supercritical |
| Evaporation | CVD | Electron beam | Plasma | Vapor |
| Evaporation | CVD | Electron beam | Plasma | Liquid |
| Evaporation | CVD | Electron beam | Plasma | Supercritical |
| Evaporation | CVD | Electron beam | Supercritical | Vapor |
| | | | Extraction | |
| Evaporation | CVD | Electron beam | Supercritical | Liquid |
| | | | Extraction | |
| Evaporation | CVD | Electron beam | Supercritical | Supercritical |
| | | | Extraction | |
| Evaporation | CVD | Electron beam | UV | Vapor |
| Evaporation | CVD | Electron beam | UV | Liquid |
| Evaporation | CVD | Electron beam | UV | Supercritical |

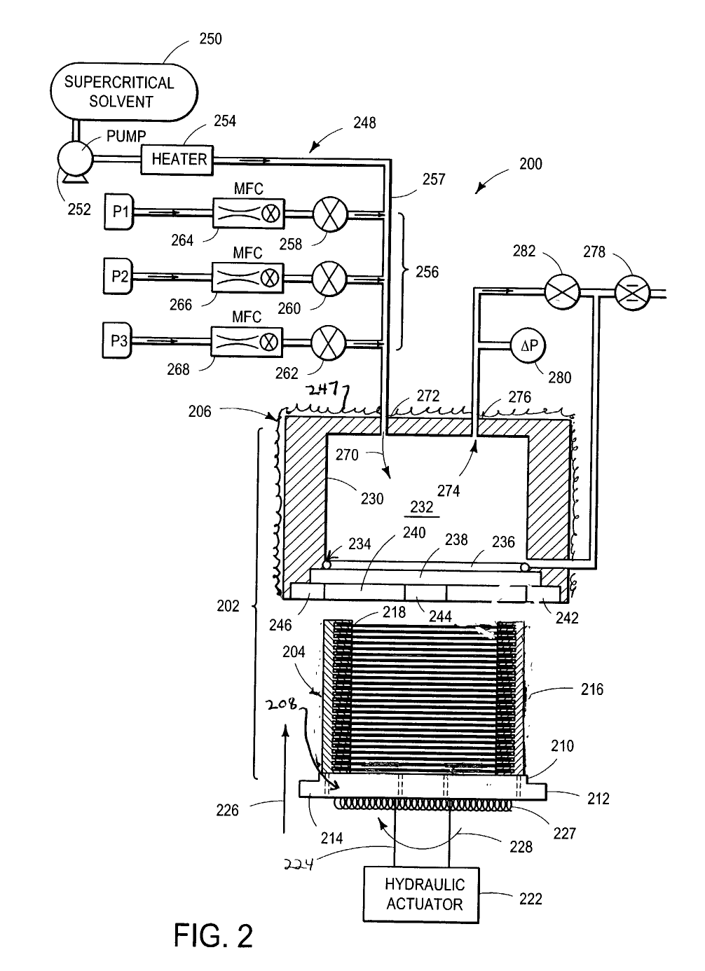

FIG. 2 is a midsectional view that shows one embodiment of a supercritical reactor vessel 200 which may be used for the first supercritical infusion chamber 126 or the second supercritical infusion chamber 136. A cylindrical pressure vessel 202 is formed as the union between a male component 204 and a female component 206. The male component 204 contains base 208 with a vertical step-shoulder 210. Step-shoulder 210 is partly circumscribed by one or more locking lugs 212 and 214. Base 208 is connected to a rising cylindrical tubular wall 216 providing a comb structure 218 for retaining a plurality of wafers, such as wafer 220. A pneumatic or hydraulic actuator 222 uses piston 224 to raise male component 204, e.g., in the direction of arrow 226 for sealing engagement with female component 206 against step-shoulder 210. The pneumatic or hydraulic actuator 222 also twists male component 204, e.g., in the direction of arrow 228, for engagement of locking lugs 212, 214 with female component 206. A heating coil 227 is optionally used to facilitate deposition reactions.

Female component 206 contains a wall 230 that defines a deposition chamber 232. Wall 230 is countersunk to form an interior step 234 that retains a flexible pressure ring-seal 236. When male component 204 is fully inserted into the deposition chamber 232, the flexible ring-seal 236 contacts step-shoulder 210 to withstand pressures within the deposition chamber 232. The wall 232 contains a horizontal slot 238 beneath ring-seal 236 that extends to a slightly greater diameter than locking lugs 212, 214 for receipt thereof within slot 238. A radially inboard lip 240 protrudes beneath slot 238 and is machined with openings 242, 244, 246 that permit the passage of locking lugs, such as locking lugs 212, 214 when male component 208 is being raised for insertion into deposition chamber 232. Once the locking lugs 212, 214 have passed their respective openings 242, 246, twisting of piston 224 in the direction of arrow 228 causes the locking lugs 212, 214 to ride over the radially inboard lip 240. This locking feature prevents the unintentional separation of male component 204 and female component 206. A thermal coil 247 is optionally used to facilitate deposition reactions by heating the depositon chamber 232 or, alternatively, to prevent reaction of inflow 270 on the wall 230 by cooling of deposition chamber 230.

Female component 206 is coupled with a chemical fluid deposition manifold 248 which may be operated under either supercritical or subcritical conditions. A supercritical solvent supply 250 feeds pump 252, which is optionally followed by a heater 254 to adjust temperature of the supercritical solvent. An array 256 of precursor feeds including a first precursor P1, a second precursor P2, and a third precursor P3 which are added to the supercritical solvent in line 257 by selective actuation of automated valves 258, 260 and 262 under the control of mass flow controllers 264, 266, and 268. The mass flow controllers 264, 266 and 268 deliver predetermined amounts of precursors P1, P2 and P3, as needed for example, to form mixed metals or mixed metal oxides of a predetermined stoichiometry. Inflow 270 enters deposition chamber 232 from inlet 272, and outflow 274 drains through outlet 276. A showerhead or baffle plate arrangement may distribute the flow evenly across the chamber. During deposition, a flow control valve 278 balances the mass of outflow 274 and inflow 270 to maintain a constant pressure within deposition chamber 232, as determined by a pressure transducer 280. Alternately, the precursor may be added as the chamber is being pressurized to its reaction pressure and the vessel may then be sealed. Valve 282 may be opened to facilitate purging of the deposition chamber 232 when deposition is complete.

In operation, wafer 220 and/or other additional wafers in a batch processing run are placed on comb structure 218 by the action of robotic arm 102 (shown in FIG. 1). A single wafer or batches of twelve, twenty-five, or another number of wafers may be infused at once. Hydraulic actuator 222 raises male component 204 in the direction of arrow 226 for insertion into deposition chamber 232 with ring-seal 236 engaging step-shoulder 210, and twists male component 204 in the direction of arrow 228 to engage locking lugs 212, 214 with the radially inboard lip 240. Flow control valve 278 and valve 282 are closed, and pump 252 is actuated to charge deposition chamber 232 with supercritical solvent 250. Heating coils 227 and 247 may be energized to heat the wafer 220 on comb structure 218. When deposition chamber 232 is fully pressurized according to measurement by pressure transducer 280, flow control valve 278 is opened, as are automated valves 258, 260, and 262. Mass flow controllers 264, 266, and 268 govern the operation of automated valves 258, 260 and 262 to deliver predetermined amounts of precursors P1, P2, and P3 capable of forming films of a desired stoichiometry on wafers 220. Alternately, the deposition chamber 232 may be isolated after the precursor has been introduced and the desired pressure has been reached, with the reaction proceeding in a static batch mode. When deposition is completed, valves 258, 260, 262 are closed, and deposition chamber 232 is purged of precursor vapor by continuing action of pump 252 on the supercritical solvent 250.

When deposition chamber 232 is purged of precursor vapor, flow control valve 278 and valve 282 are opened to drain deposition chamber 232 of solvent. Alternately, the deposition chamber 232 may be depressurized directly without a purge step. Hydraulic actuator 222 rotates base 208 in contra-direction to arrow 228, and lowers base 208 in contra-direction to arrow 226.

It will be appreciated that the precursors P1, P2, P3 may be in solid, liquid or gaseous form, and there may be any number of precursors. Solids or liquids may be predissolved in either liquid, gaseous, or supercritical carrier fluids. Optionally, one of the precursors P1, P2, P3 may be replaced by a reagent, such as oxygen, that may be used in the formation of metal oxides

Process Chemistry

Mesoporous materials may be prepared in two or more principal steps: (i) a suitable template is prepared (for example in the template deposition chamber 117); and (ii) the template is permeated with a precursor (for example, within the supercritical infusion chambers 126, 136) to deposit a reaction product within the template. In some embodiments, the template is removed, leaving behind the mesoporous material. The sequential process allows separate control over the template deposition and the matrix formation. As opposed to the '457 patent where everything occurs in a single reaction, different solvents and different process conditions can be used for the two steps.

The first step includes providing a template having a desired mesoscale structure. For example, suitable templates for the formation of mesoporous metal oxide films can be made from block copolymers, such as polyethylene oxide-polypropylene oxide-polyethylene oxide (PEO-PPO-PEO) triblock copolymers. These copolymers can be spin-cast from solution onto a substrate. During evaporation of the solvent, the block copolymer self-assembles into distinct phase domains where the different phases are formed from the different blocks. A catalyst or reagent, e.g., p-toluene sulphonic acid (PTSA) can be included in the template, and is partitionable in one of the template phases. For example, PTSA is partitioned in the PEO phase of a PEO-PPO-PEO triblock copolymer. The domains of this phase provide the mesoscale structure that, at least in part, dictates the final structure of the mesoporous material.

In the second step, a precursor is infused into the template layer. The catalyst or reagent sequestered within the template initiates a local condensation reaction of the precursor, and the reaction product, e.g., SiO₂, deposits onto domains of the template structure. Precursor deposition yields a composite formed of the template and a matrix formed of the precursor deposition product around the template. In some embodiments, the precursor is delivered using a delivery agent or solvent, such as a supercritical fluid or near-supercritical solution. For example TEOS dissolved in supercritical or near supercritical CO₂ can deposit silica within a mesoporous polymer template. The supercritical solvent increases the mass transfer of the TEOS through the polymer as well as removal of the reaction by-products. This may result in a wider range of TEOS to polymer ratios than is accessible in the single-step process. Additional reagents and/or catalysts necessary for deposition of the reaction product may be delivered with the precursor. For brevity, the term precursor mixture refers to the precursor, precursor delivery agent, and any other components delivered with the precursor that assist in or enable the precursor to permeate the template, and/or enable the reaction product to deposit within the template.

In some embodiments the template is removed, leaving a mesoporous structure of the precursor deposition product, e.g., a mesoporous silica matrix. Alternately, the silica matrix may be doped with hydrocarbons, fluorine, boron, phosphorous, germanium, or other dopants. The mesoporous structure has a similar morphology to that of the template, with the precursor deposition product occupying regions corresponding to the domains of one particular phase. Template removal is usually accomplished by decomposition of the template material, e.g., by calcination or plasma reaction, or by solvent extraction. The final mesoporous film may also have a morphology different from the template as a result of expansion of one of the phases of the template due to preferential absorption of the precursor. For example, the template may have a 2-dimensional cubic cylindrical morphology whereas the infused film may have a 3-D spherical cubic or hexagonal morphology.

Templates can be prepared from any material or combination of materials that possess the desired level of mesoscopic ordering, that are permeable to a desired precursor mixture, and are compatible with the precursor condensation chemistry. One class of template-forming materials is the class of block copolymers. Block copolymers contain a linear arrangement of blocks. A block is a portion of a polymer molecule in which the monomeric units have at least one constitutional feature, i.e., the chemical makeup of the blocks, or configurational feature, i.e., the arrangement of atoms in the blocks. This constitutional feature may be absent from adjacent blocks. Under suitable conditions, such as favorable temperature and relative concentration ranges, some block copolymers self assemble into domains of predominantly a single block type.

Suitable block copolymers include, for example, polyethylene oxide-polypropylene oxide-polyethylene oxide (PEO-PPO-PEO) triblocks, polystyrene-polyethylene oxide (PS-PEO) diblocks, poly(dimethylsiloxane)-polyethylene oxide diblock and triblock copolymers, and polyethylene-polyethylene oxide block copolymers.

In some embodiments, block copolymers include at least one block that has a particular affinity for one or more components of a precursor mixture. By inherently attracting selected components of the precursor mixture, the template enhances permeation of those components in desired phase domains of the block copolymer. For example, at least one of the blocks can be hydrophilic and/or CO₂-philic, thereby enhancing permeation of water, hydrophilic precursors and/or CO₂ within those blocks. Additionally, one block can be hydrophilic and a second block can be CO₂-philic. As another example, a block can be selected with which the precursor liquid selectively reacts. Additionally, a block can act as a catalyst for the reaction of the precursor to form the matrix.

Furthermore, block copolymers can include at least one other block that is phobic to a precursor mixture or precursor mixture component. A block that is phobic inhibits permeation of the precursor mixture, or component, from entering the template phase composed of the block. For example, a block copolymer can include a hydrophilic block and a hydrophobic block. A supercritical water solvent can be selectively partitioned into template phase composed of the hydrophilic block phase. In another example, one block can exhibit very low permeability to a supercritical solvent solution while the other block is readily swollen by it.

In some embodiments, block copolymers are chosen that contain at least one block that can serve as a positive or negative photoresist. These block copolymers are lithographically patterned prior to, during, or after infusion of the matrix-forming precursor liquid.

The morphology of a phase-separated block copolymer can vary. For example, the block copolymer can include discrete domains of a first block type embedded in a matrix of a second block type. Alternatively, the block copolymer can include interpenetrating domains.

In addition, domain size can be varied as desired. Domain size can be influenced by molecular weight of the blocks. In some cases, a characteristic dimension of domain size is proportional to the square root of the molecular weight. Domains can be in the nanometer to tens-of-nanometer range. Alternatively, the domains can be on the order of micrometers, or larger in size. The mesoporous structure of material deposited from the precursor liquid is derived from the domain structure of the template. Hence domain size is usually controlled to satisfy the properties of the mesoporous material in the final application. Factors affecting domain size and structure are discussed below.

Block copolymers can also exhibit additional phase ordering within template domains that further influence the morphology of the mesoporous material. For example, crystalline or liquid crystalline polymeric units display varying degrees of translational or orientational order between units. One or more blocks can be chosen to have these properties, so that the polymeric units order within the template domains formed of these blocks. Mesoporous material deposited in these domains may manifest artifacts of this ordering, such as periodic variations in density within the ordered domains. In instances where at least one block is semi-crystalline, the mesoporous material can exhibit structures arising both from the phase separated copolymer domains and the crystal structure in one or both domains. This can occur under conditions in which infusion and reaction of the precursor liquid proceeded in the amorphous regions but not in the crystalline regions of a semi-crystalline phase domain. The presence of a least one semi-crystalline phase domain during the templating process can also reduce or prevent the bulk dilation of the template.

Several parameters affect block copolymer morphology. These parameters can be varied to tailor the template structure to a desired form. Typically, the chemical structure of the monomeric units making up each block dictates the interaction between monomers forming each block and chemical bonding between blocks, both of which influence block copolymer morphology. For example, inclusion of a mesogenic moiety in a monomer can result in ordering within domains, as described above. Furthermore, monomer chemistry also influences block miscibility, and will strongly influence phase separation/self assembly of the block copolymer into phase domains.

The relative lengths of the blocks in the block copolymer also influence template morphology. Phase morphology can vary from spheres to cylinders to alternating lamellae depending on the relative length of each block. For example, a block copolymer containing short blocks of unit A, and relatively longer blocks of unit B, can result in spheres containing blocks of unit A within a continuous phase of the longer blocks of unit B. Alternating lamellae tend to form when the blocks are about the same length, and cylinders form for intermediate cases.

In some embodiments, the copolymer architecture is manipulated by the addition of homopolymers and/or swelling agents, such as diacrylphthalate, squalene, and/or polypropylene oxide. For example, one or more homopolymers of one or more of the blocks in the block copolymer can be added to increase the repeat distance of the blocks. Examples of this technique are described in U.S. patent application Ser. No. 09/814,891 and by Urbas et al. (Adv. Material, 12, 812,2000). Furthermore, swelling agents that exhibit lower solubility in supercritical solvents than does the precursor liquid that can be selective or non-selective for a given block can be applied to the template. In some cases, selective swelling agents can induce order-disorder transitions within the template, such as transitions between ordered states having different morphologies. These transitions further modify the copolymer architecture. Selective swelling is further discussed, for example, by K. J. Hanley, T. P. Lodge, and C. I. Huang (Macromolecules, 33, 5918, 2000).

In further embodiments, template morphology is altered during the precipitation reaction. For example, reagents and reaction byproducts can selectively partition into different domains, leading to dilation of the template, which increases the size of those features of the mesoporous material compared to the corresponding features in the pre-dilated template.

In general, the thickness of the template layer can be varied as desired. Template thickness often determines the thickness of the mesoporous film. In some embodiments, template films are less than one micrometer thick, e.g., less than 0.5 micrometers, less than 0.3 micrometers, or less than 0.1 micrometers. In alternative embodiments, template films are at least one micrometer thick, e.g., at least 2 micrometers, at least 3 micrometers, at least 5 micrometers, or at least 10 micrometers thick. In general, templates are not limited to thin films. Bulk templates can also be used to prepare bulk mesoporous materials.

In another embodiment, a template may be composed of a homogeneous polymer matrix physically mixed with one or more other components that function as porogens. A porogen is any material that causes a difference in the partitioning or reactivity of the precursor and/or alters the structure of the material produced using the matrix polymer. These porogens include nanospheres of another polymer, or mixture of polymers, that may be modified to improve compatibility with the matrix polymers, organic compounds or assemblies of organic compounds or inorganic materials such as salts and clays.

Template layers are prepared by first disposing or depositing a layer of template-forming material onto a substrate. The substrate provides mechanical support for the template and the resulting mesoporous film. The template can be an integral part of a final product if the mesoporous film is part of a composite article (e.g., a microchip can include a mesoporous layer as part of a stack of thin films on a silicon wafer substrate). Suitable substrates include, for example, silicon wafers, glass sheets, polymer webs, silicon carbide, gallium nitride, metal, metal oxide, or semiconductor layers deposited onto these substrates. The template material(s) can be disposed on the substrate in a number of ways.

Generally, the template is disposed on the substrate in a way that consistently yields a template layer having a desired thickness and composition. For example, the template material can be coated onto the substrate, e.g., spin-cast, knife-coated, bar-coated, gravure-coated, or dip-coated. The template material can be coated out of solution from which the solvent is evaporated to yield a layer of template material. The template material can be vapor-deposited or evaporated onto a substrate.

A catalyst can be incorporated into the template layer, for example, as may be required to initiate the precipitation of the precursor onto the template. In some embodiments, the catalyst is sequestered in one phase of the block copolymer template to assure that precipitation occurs primarily within the domains of that phase. In other embodiments, a catalyst that is activated by exposure to heat, light or radiation is incorporated into one or more of the phase domains. One example of such a catalyst is a photoacid generator. The catalyst can then be activated in selected regions of the template by selective exposure to light, as in a patterning process. In another embodiment, an inhibitor to the reaction involving the precursor can be incorporated into one or more of the phase domains.

The catalyst can be included in the coating solution from which the template layer is cast, or it can be applied to the template layer in a separate process step, for example, when the catalyst is a distinct chemical compound that does not react with the block copolymer of the template. In some cases, the catalyst can be chemically incorporated into a block of the block copolymer, or can be the block itself.

The chemical nature of the catalyst is determined primarily by the precursor material and nature of the desired precipitation reaction. Some acid catalysts, such as PTSA, are suitable for initiating metal oxide condensation from their alkoxides, e.g., silica condensation from TEOS. Compatibility with the template, or at least one phase of the template, is another factor in catalyst selection. PTSA is a suitable catalyst for use with a PS-PEO template, and is sequestered in the PEO domains. A non-limiting summary of metal oxide precursors and catalyst systems is available in Sol-Gel Science by Brinker and Scherer.

Precursor liquid is delivered by way of a delivery agent, e.g., in a supercritical solvent. For example, the precursor can be dissolved in a supercritical, near supercritical, or subcritical fluid, forming a solution that is then infused into the template. The precursor liquid can react with a reagent or catalyst partitioned in one or more of the template domains to precipitate a matrix having a mesoporous structure formed around the template.

In the discussion that follows, precursor delivery in both batch and continuous mode is described by way of example. A batch run in which a precursor in a supercritical solution is delivered to a template layer involves the following general procedure.

A single substrate or multiple substrates, such as groups of twelve or twenty-five, are placed in a reaction vessel. The reaction vessel is filled with solvent containing a known amount of precursor. The contents of the reaction vessel are brought to a specified temperature and pressure placing the solvent in a supercritical or near-supercritical state. The precursor-solvent solution permeates the template. Precursor dissolved in the solvent reacts with the catalyst or other reagent, which is preferentially sequestered in specific domains within the template. The reaction vessel is maintained at this condition for a period of time sufficient to ensure that the solution has completely penetrated the template and that the precursor has reacted, precipitating a reaction product onto the template. The reaction occurs until precursor deposition is complete, for example, for one hour or for two hours, though the reaction can be complete at times much less than one hour, e.g., less than 20 minutes or less than 30 seconds. The optimal length of reaction time can be determined empirically. When the reactor has been depressurized, the substrate is removed and can be analyzed or further treated to remove the template. Alternatively a high-pressure load lock may be used so that the substrate may be removed from the infusion chamber at the end of the reaction time without depressurizing the chamber.

A continuous precursor delivery process is similar to the above batch method except that known concentrations of the supercritical or near-supercritical solution are taken from a reservoir and continuously added to the reaction vessel. The reaction vessel may contain multiple substrates. Supercritical solution containing precursor decomposition products or unused precursor is continuously removed from the reaction vessel. In some embodiments, the flow rates into and out of the reaction vessel are equilibrated, which causes pressure within the reaction vessel to remain substantially constant.

The overall flow rate is optimized according to the particular reaction. Prior to introducing precursor-containing solution into the reaction vessel, the reaction vessel can filled with neat solvent, which is the same as the solvent in the precursor solution, at supercritical or near-supercritical pressures. As a result, supercritical or near-supercritical conditions are maintained as the precursor-containing solution is initially added to the reaction vessel.

Solubility of the precursor at the reaction conditions can be verified in a variable volume view cell, which is well known in the art (see, for example, McHugh et at., Supercritical Fluid Extraction: Principles and Practice, Butterworths, Boston, 1986). Known quantities of precursor and supercritical solvent are loaded into the view cell, where they are heated and compressed to conditions at which a single phase is observed optically. Pressure is then reduced isothermally in small increments until phase separation is induced to form either a liquid-vapor or solid-vapor system.

The temperature and pressure of the process depend on the reactants and choice of solvent. Generally, temperature is less than 250° C. and often less than 100° C., e.g., less than about 90° C., 80° C., 70° C., 60° C., 50° C., or 40° C. The pressure is often between 50 and 500 bar, e.g. between 75 bar and 300 bar, 90 bar and 200 bar, 100 bar and 150 bar, 110 bar and 140 bar, or 120 bar and 130 bar. A temperature gradient between the substrate and solution can also be used to enhance chemical selectivity and to promote reactions within the template.

Solvents useful as supercritical solvents are well-known in the art and are sometimes referred to as dense gases, e.g., as shown in Sonntag et al., Introduction to Thermodynamics. Classical and Statistical, 2nd ed., John Wiley & Sons, 1982, p. 40. At temperatures and pressures above certain values for a particular substance, where these temperatures are defined as the critical temperature and critical pressure, respectively, saturated liquid and saturated vapor states are identical and the substance is in a supercritical state. Solvents that are in a supercritical state are less viscous than liquid solvents by one to two orders of magnitude. Diffusion coefficients in supercritical fluids are also typically lower than those in liquids by one or two orders of magnitude. The low viscosity of the supercritical solvent, enhanced rates of mass transfer and absence of surface tension facilitates improved transport, relative to liquid solvents, of reagent to the template and decomposition products away from the template.

The use of a supercritical solvent is particularly advantageous in ensuring complete permeation of the template layer by the solution. Furthermore, the solubility of many precursors increases in supercritical solvents, relative to the solvents in a non-supercritical state. Generally, a supercritical solvent can be composed of a single solvent or a mixture of solvents including, for example, a small amount of less than 5 mol % of a polar liquid co-solvent such as ethanol or another alcohol.

It is desirable that the reagents are sufficiently soluble in the supercritical solvent to allow homogeneous transport of the reagents. Solubility in a supercritical solvent is generally proportional to the density of the supercritical solvent. Ideal conditions for precursor transport include a supercritical solvent density of at least 0.1 to 0.2 g/cm³ or a density that is at least one third of the critical density, i.e., the density of the solvent at the critical temperature and critical pressure. Solvents that are at least one third of critical density are referred to herein as near-supercritical solvents, and solvents at lower densities are referred to as subcritical solvents.

Table 1 below lists some examples of solvents along with their respective critical properties for carbon dioxide, ethane, propane, butane, pentane, dimethylether, ethanol, water, and hexafluoroethane. These solvents can be used by themselves or in conjunction with other solvents to form the supercritical solvent. Table 2 lists the critical temperature, critical pressure, critical volume, molecular weight, and critical density for each of the solvents.

TABLE 2
CRITICAL PROPERTIES OF SELECTED SOLVENTS

| | Tc | Pc | Vc | Molecular | Pc |
|---|---|---|---|---|---|
| Solvent | (K) | (atm) | (cc/mol) | Weight | (g/cm³) |
| CO₂ | 304.2 | 72.8 | 94.0 | 44.01 | 0.47 |
| C₂H₆ | 305.4 | 48.2 | 148 | 30.07 | 0.20 |
| C₃H₈ | 369.8 | 41.9 | 203 | 44.10 | 0.22 |
| n-C₄H₁₀ | 425.2 | 37.5 | 255 | 58.12 | 0.23 |
| n-C₅H₁₂ | 469.6 | 33.3 | 304 | 72.15 | 0.24 |
| CH₃—O—CH₃ | 400 | 53.0 | 178 | 46.07 | 0.26 |
| CH₃CH₂OH | 516.2 | 63.0 | 167 | 46.07 | 0.28 |
| H₂O | 647.3 | 12.8 | 65.0 | 18.02 | 0.33 |
| C₂F₆ | 292.8 | 30.4 | 22.4 | 138.01 | 0.61 |

The terms “reduced temperature,” “reduced pressure,” and “reduced density” are often used in the context of supercritical solvents. The reduced temperature of a particular solvent is temperature measured in Kelvin divided by the critical temperature measured in Kelvin. Reduced pressure and reduced density are also calculated by dividing observed values of absolute pressure and temperature by the critical values. For example, at 333 K and 150 atm., the density of CO₂ is 0.60 g/cm3. Therefore, with respect to CO₂, the reduced temperature is 1.09, the reduced pressure is 2.06, and the reduced density is 1.28. Many of the properties of supercritical solvents are also exhibited by near-supercritical solvents. Near-supercritical solvents are hereby defined as solvents having a reduced temperature and a reduced pressure greater than 0.8 and 0.6, respectively, but not both greater than 1. One set of suitable conditions for template infusion include a reduced temperature of the supercritical or near-supercritical solvent of between 0.8 and 1.6 and a critical temperature of the fluid of less than 150° C. In this application, when a fluid, solvent or other solution is referred to as “supercritical”, it is understood to describe both supercritical and near-supercritical conditions.

Carbon dioxide (CO₂) is a particularly preferred choice of solvent because its critical temperature of 31.1° C. is close to ambient temperature, which permits the use of moderate process temperatures, (e.g., less than 100° C.). Carbon dioxide is also unreactive with many desirable precursors and is an ideal media for reactions between gases and soluble liquids or solid substrates. However, other solvents including but not limited to water, ethane, propane, dimethyl ether, hexafluoroethane, SF₆, ethylene, N₂O, Xe, ammonia and mixtures thereof may also be used in place of or in combination with carbon dioxide as the supercritical solvent.

Precursors are chosen to yield the desired material in the template following reaction. Desired materials can include:

doped and undoped silicon oxides, e.g., SiO₂, carbon-doped oxides, fluorinated silica glass, and SiO₂ doped with boron, phosphorous, or germanium;

mixed metal or mixed metal oxides, e.g., a superconducting mixture such as Y—Ba—Cu—O;

metals, e.g., Cu, Pt, Pd, and Ti;

elemental semiconductors, e.g., Si, Ge, and C;

compound semiconductors, e.g.,

Group III-V semiconductors such as GaAs and InP,

Group II-VI semiconductors such as CdS, and

Group IV-VI semiconductors such as PbS; and

Oxides, such as metal oxides of Si, Zr, Ti, Al and V

Any of the foregoing materials may be doped with additional constituents. For example, fluorine, boron, phosphorous, or germanium are particularly useful dopants in silica and other materials used for making semiconductor circuits. Precursors for oxide deposition include, for example, alkoxides such as TEOS for silica deposition, metal carboxylates, and metal ketonates.

Any reaction yielding the desired material from the precursor can be used. Naturally, the precursors and reaction mechanisms should be compatible with the chosen method of precursor delivery to the template. Low process temperatures, e.g., less than 250° C., 200° C., 150° C., or 100° C. for CO₂) and relatively high fluid densities (e.g., greater than 0.2 g/Cm³ for CO₂) in the vicinity of the template are preferred. If the template temperature is too high, the density of the fluid in the vicinity of the substrate approaches the density of a gas, and the benefits of the solution-based process are lost.

In addition, a high template temperature can adversely affect template morphology. For example, the reaction can involve:

reduction of the precursor, e.g., by using H₂ or H₂S as a reducing agent;

oxidation of the precursor, e.g. by using O₂ or N₂O as an oxidizing agent); or

hydrolysis of the precursor by adding H₂O followed by a condensation reaction.

An example of a hydrolysis reaction is one using water as the reaction reagent to react with a metal alkoxide precursor. For example, water may react with titanium tetraisopropoxide to produce a metal oxide structure, such as TiO₂. The reaction can also be initiated by optical radiation, e.g., photolysis by ultraviolet light. In this case, photons from the optical radiation are the reaction agent.

In some cases, the precursor delivery agent can participate in the reaction. For example, in a supercritical solution including N₂O as an additional solvent and metal precursors such as organometallic compounds, N₂O can serve as an oxidizing agent for the metal precursors yielding metal oxides as the desired material. In most cases, however, the solvent in the SCF is chemically inert.

The product of precursor delivery to the template is a composite, e.g., in a film or bulk layer, of the template material and the reaction product. The template material can be removed to yield a mesoporous structure of the reaction product. In such cases, the template material is usually decomposed, using one or more of a number of techniques. For example, a block copolymer template can be decomposed thermally by calcinations. Template removal from silica-polymer composites is well suited to calcinations, as the decomposition temperature of most polymers (e.g., about 400° C.) does not affect the silica structure. Alternatively, the template can be decomposed or dissolved by chemical, photochemical or plasma techniques. The composite layer can be exposed to solvents or etchants that decompose the template but not the reaction product. Photochemical techniques include the decomposition of the template by exposure to the appropriate radiation, such as ultraviolet radiation. Either reducing plasmas, such as H₂/N₂ mixtures, or oxidizing plasmas, such as O₂/N₂ mixtures can also decompose and remove the template.

Decomposition of the template material can be performed in the presence of a fluid to facilitate template removal. In some cases, the precursor delivery agent can provide this function. For example, supercritical or near-supercritical CO₂ or CO₂/O₂ mixtures can exploit the transport advantages of SCFs in mesoporous materials to expedite removal of the decomposed template

After template removal, the mesoporous material can be further modified in a further process (or processes). For example, it can be necessary to modify the hydrophilic silica surface that is obtained from alkoxide condensation, for example, by reaction with 1,1,1,3,3,3-hexamethyldisilazane or (CH₃)₃SiCl to cap dangling —OH groups and produce a hydrophobic surface. In many cases, this can be achieved using SCF CO₂ solutions of reagents. These reactions can include the use of commercial organosilane coupling agents including mono-, difunctional and trifunctional coupling agents, such as those described in C. J. Brinker and G W. Scherer, Sol-Gel Science: the Physics and Chemistry of Sol-Gel Processing, Academic Press, San Diego Calif., 1999, p. 662.

Further treatment of the mesoporous material can also be performed in the presence of the precursor delivery agent, e.g., in the presence of a supercritical or near-supercritical fluid mixture (e.g., CO₂ or CO₂/O₂), thereby exploiting the transport advantage of supercritical solvents in mesoporous materials.

In further embodiments, the mesoporous film is patterned after template removal. For example, the mesoporous film can be patterned using lithographic techniques, such as photolithography and electron beam lithography, as described above.

Mesoporous materials can be applied in the areas of low k dielectrics, catalysis, molecular separations, optical coatings, optoelectronics, photonics, and sensors, for example. Mesoporous silica films are of interest to the microelectronics industry, e.g., in the semiconductor device industry. In particular, thin mesoporous films are potentially useful as low dielectric constant layers in integrated circuits. Mesoporous metal oxide materials can also be used to provide optical coatings on optical fibers and other optical components and devices. Mesoporous materials can provide a low refractive index layer. Moreover, by adjusting the volume fraction of the pores in the mesoporous material, the material refractive index can be selected to be any value within a range of values between the refractive index of the metal oxide and air. Alternatively, the pores may be filled with a fluid (e.g., a high refractive index fluid), and the materials refractive index selected to be within a range of values between the refractive index of the metal oxide and the fluid. Mesoporous materials can be useful for catalysis and in molecular separations.

### EXAMPLES

These nonlimiting examples demonstrate materials and methods for practicing the concepts disclosed above.

Chemicals:

A polyethylene oxide-polypropylene oxide-polyethylene oxide triblock copolymer, Pluronic® F-127 (EO₁₀₆PO₇₀EO₁₀₆) was obtained from BASF of Mount Olive, N.J. TEOS, PTSA and ethanol were obtained from Aldrich of St. Louis, Mo. All chemicals were used as obtained without further purification. Carbon dioxide (SFC grade) was obtained from Air Products and used as received.

### Example 1

### Silica Mesoporous Film from TEOS

In this example, to demonstrate proof of principle, an experiment was performed using a combination of separate commercial and small-scale bench top apparatus to perform the steps that would take place in the different modules of this invention. Silicon substrates, 2″ in diameter were obtained by laser cutting standard 200 mm silicon wafers. Thin films of Pluronic® F127 were spin cast onto the silicon substrates at 2500 rpm using a 10 wt. percent solution in ethanol containing a small amount (0.8 wt %) of p-toluene sulfonic acid (PTSA) and 5% water. After drying, the block copolymer film containing PTSA was approximately 13,000 Å thick. The substrate was then placed into a high-pressure reactor vessel. The reactor was constructed from opposed stainless steel hubs sealed with a metal seal ring. The hubs were tapped to provide ports for measuring inside temperature and pressure and for the introduction and exit of carbon dioxide carrier medium.

The reactor was sealed and the film was exposed to a 0.08 wt % solution of TEOS in humidified CO₂ at 60° C. and 122 bar for 2 hours using a high pressure syringe pump (ISCO, Inc). Temperature was maintained at 60° C. using external band heaters. After 2 hours, pure CO₂ was flushed through the reactor at the rate of 10 mL/min for 30 min. The reactor was then slowly vented to atmospheric pressure. The composite film was then removed from the reactor and weighed. The mass of the film increased by 60% and the film thickness increased to 19,000 Å following the TEOS reaction.

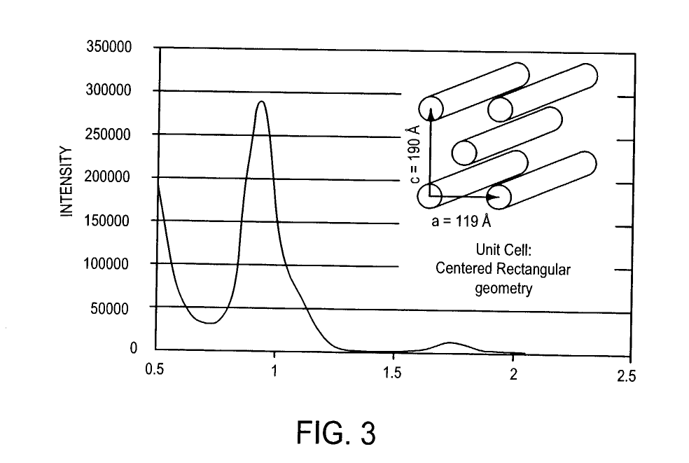

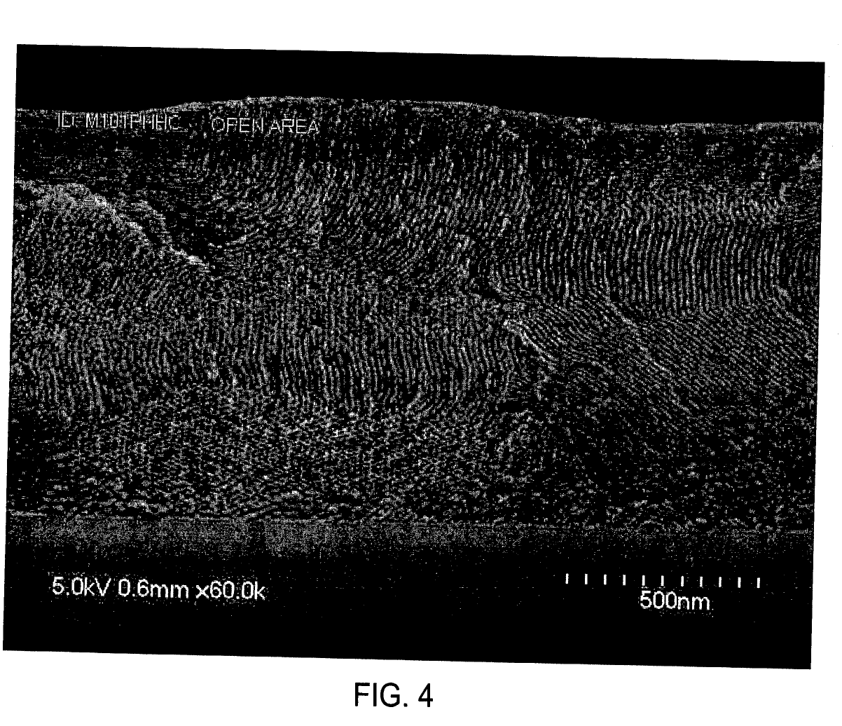

The polymer template was then removed by exposure to a hydrogen plasma at 400° C. for 5 minutes in a multistation Sequel™ module. The mesoporous silica film thus obtained was dipped in liquid hexamethyldisilazane at 100° C. for 5 minutes to replace Si—OH terminated groups with Si—O—Si(CH₃)₃ terminated groups. The final film was 13,500 Å thick and had a dielectric constant of 2.03 with a hardness of 0.31 GPa. The dielectric constant was measured using the mercury probe method after deposition of an SiO2 cap, and the hardness was measured by nanoindentation. The calcined film was examined by XRD (FIG. 3), SEM (FIG. 4) and TEM to confirm crystalline structure and mesoscale structure with an ordered cylindrical morphology. Grains with cylinder orientations parallel to and perpendicular to the plane of the image were evident in the micrograph.

### Example 2

### Silica Mesoporous Film from TEOS

In another example, to demonstrate proof of principle for a batch infusion chamber, an experiment was performed using a combination of separate commercial and small-scale bench top apparatus to perform the steps that would take place in the different modules of this invention. Silicon substrates 2″ in diameter were obtained by laser cutting standard 200 mm silicon wafers. Thin films of Pluronic® F127 were spin cast onto both high and low resistivity silicon substrates at 2500 rpm using a 10 wt. percent solution in ethanol containing a small amount (0.8 wt %) of p-toluene sulfonic acid (PTSA) and 5% water. The high resistivity (>5 ohm-cm) wafers are used for transmittance FTIR analysis whereas the low resistivity (<0.02 ohm-cm) substrates are used for electrical property measurements. After drying, the block copolymer films containing PTSA were approximately 13,000 Å thick. Five wafers with the spun-cast block copolymer template were then placed on a multiwafer holder inside a high-pressure reactor vessel. The reactor was constructed from opposed stainless steel hubs sealed with a metal seal ring. The hubs were tapped to provide ports for measuring inside temperature and pressure and for the introduction and exit of carbon dioxide carrier medium.

The reactor was sealed and pressurized with humidified CO₂ at 40° C. and 68 bar. The temperature of the reactor was then raised to 60° C. and TEOS was added to the reactor using a high pressure sampling valve. Additional CO₂ was used to deliver the TEOS to the reactor and to bring the pressure to 122 bar. The templates were then exposed for 10 minutes to the CO₂ containing 0.3% TEOS and saturated with water. After 10 minutes the reactor was vented to atmospheric pressure. The 5 wafers with composite films were then removed from the reactor and analyzed. The composite films were found to be similar for all 5 wafers. The 5 wafers were then detemplated by exposure to a hydrogen plasma for 8 minutes followed by in situ exposure to vapor phase HMDS for 30 minutes in a multi station Sequel™ module. The resulting mesoporous silica film had a dielectric constant of 2.2 with a hardness of 0.35 GPa.

### Example 3

### Curing and Detemplating

The films produced after the supercritical infusion step are a composite comprised of the organic template and a partially condensed inorganic network. The final film is produced by removing the template and leaving a mesoporous silica film behind. In one example of a preferred embodiment, the cure/detemplating chamber 146 (FIG. 1) contains four segments A, B, C and D, each with independent temperature control to be used for curing and detemplating. Based on throughput management requirements different combinations of the segments A-D are used for curing and detemplating. The curing process provides enhanced condensation of the inorganic network to form a mechanically stable film. Curing stations may be equipped with showerheads to provide a specific atmosphere for example, an oxygen and/or moisture rich atmosphere may be provided.

Thermal curing is an optional process step that preferably occurs below the decomposition temperature of the template polymer, for example, at temperatures ranging between 50° C. and 200° C. For example, three segments A, B and C within cure/detemplating chamber 146 are maintained at 100° C. and wafers spend one third of the total cure residence time at each station. The three segments A, B and C may have a step-ramped heating profile between 50° C. and 200° C. to cure the composite film at increasing temperatures. For example, three stations A, B and C are respectively maintained at 50° C., 100° C. and 150° C. The fourth segment D is the detemplating station, which provides a hydrogen plasma source while the platen is maintained at a temperature between 50° C. and 500° C. The hydrogen plasma generator operates at relatively low power (10-500 W RF), which allows the plasma to decompose the block copolymer without extensively damaging the film. In one example, where a Sequel™ module is used for the detemplating, the platen is maintained at 400° C. while a 2:1 mixture of H₂ and N₂ flows from showerhead 151 and the wafer is exposed to a high frequency plasma for 8 minutes. After the plasma detemplating step the resulting film is comprised of a mesoporous silica network.

### Example 4

### Dehydroxylation and Cap Deposition

The mesoporous film produced in Example 3 consists of an SiO₂ network terminated with Si—OH groups, which can be replaced with a non-polar group to produce a hydrophobic low dielectric constant film. In addition, integration schemes require a non-porous cap to be deposited over the low-k film. In one example of a preferred embodiment, dehydroxylation chamber 154 (FIG. 1) also comprises four segments E-H with independent temperature and atmosphere control for use in dehydroxylation and cap deposition. Again, based on throughput management requirements different combinations of the four segments can be used for the dehydroxylation and cap deposition. In this example, three segments E, F and G are used for dehydroxylation by exposure to hexamethyldisilazane which replaces the hydrophilic Si—OH groups with hydrophobic Si—O—Si(CH₃)₃ groups. The three segments E, F and G are either maintained at the same temperature (e.g. 400° C.) or at different temperatures. For example the first station E is held at 400° C. to initially drive off any adsorbed moisture. The second segment F and third segment G can be at a lower temperature to maximize the formation of stable Si(CH₃)₃ groups. The fourth segment H in this example is used to deposit a nonporous cap layer, such as PECVD SiO₂, silicon nitride etc. For example, 1000 Å of silicon nitride is deposited at 400° C. by a PECVD process from gaseous precursors NH₃ and SiH₄ with N₂ as the carrier gas. The wafer at this stage is ready for further integration processes. FIG. 3 depicts X-ray diffraction data showing the crystal structure of the oxide film produced according to Example 1. The mesoporous oxide film demonstrates the presence of cylindrical pores with a unit cell having a 2 dimensional body centered rectangular geometry. FIG. 4 depicts a scanning electron micrograph of the mesoporous oxide film produced according to Example 1. The image is taken at 60,000× magnification as a vertical midsection view through the mesoporous region. The oxide forms the walls of a mesoporous structure with a plurality of cylindrical pores where the template material has been removed. The pores are ordered to form a generally 2 dimensional body centered rectangular structure. This ordered structure imparts strength to the mesoporous oxide material. Electrical measurements of the mesoporous oxide determined a dielectric constant k of 1.78.

The foregoing discussion is intended to illustrate certain features by way of example with emphasis upon the preferred embodiments and instrumentalities. It will be appreciated that the various functionalities described above may be performed by similar means, such as by separating functions for dual-purpose processing chambers for implementation in separate processing chambers. Accordingly, the disclosed embodiments and instrumentalities are not exhaustive of all options or mannerisms for practicing the disclosed principles herein. The inventors hereby state their intention to rely upon the Doctrine of Equivalents in protecting the full scope and spirit of the invention.

We claim:

1. A system for deposition of mesoporous material on a substrate, comprising:
a plurality of processing chambers, in combination, capable of forming the mesoporous material on the substrate; and
a controller configured to govern processing of the substrate through the plurality of processing chambers in forming the mesoporous material on the substrate,
the plurality of processing chambers comprising at least one template deposition chamber configured to apply a mesoporous template-forming material to the substrate, and
an infusion chamber configured to infuse the mesoporous template-forming material with a mesoporous matrix-forming material.

2. The system of claim 1, further comprising a robotic conveyance for transporting the substrate between the plurality of processing chambers.

3. The system of claim 2, wherein the substrate includes a wafer and the robotic conveyance includes a wafer handling device.

4. The system of claim 1, wherein the template deposition chamber comprises a wafer coating device.

5. The system of claim 1, wherein the wafer coating device is selected from the group consisting of a spin-coater, a print coater, and a chemical vapor deposition system.

6. The system of claim 1, wherein the template deposition chamber comprises means for initiating a polymerization reaction in the mesoporous template-forming material.

7. The system of claim 1, wherein the template deposition chamber comprises a precursor liquid capable of forming a polymer template.

8. The system of claim 1, wherein the infusion chamber operates under supercritical conditions.

9. The system of claim 1, further comprising means for maintaining the fluid at a supercritical state within the infusion chamber.

10. The system of claim 1, wherein the fluid is selected from the group consisting of carbon dioxide, ethane, propane, butane, pentane, dimethylether, ethanol, water, and hexafluoroethane.

11. The system of claim 1, wherein the fluid comprises carbon dioxide.

12. The system of claim 1, wherein the supercritical infusion chamber comprises a chemical vapor deposition reactor configured to operate at supercritical conditions.

13. The system of claim 1, wherein the supercritical infusion chamber comprises a field generator positioned to orient mesoporous domains of the mesoporous matrix-forming material in a predetermined matrix orientation.

14. The system of claim 1, wherein the mesoporous matrix-forming material comprises a precursor liquid capable of forming silica.

15. The system of claim 1, wherein the mesoporous matrix-forming material comprises a precursor liquid capable of forming carbon-doped silica.

16. The system of claim 1, wherein the mesoporous matrix-forming material comprises a precursor liquid capable of forming silica doped with a material selected from the group consisting of fluorine, boron, phosphorous, germanium, and combinations thereof.

17. The system of claim 1, wherein the mesoporous matrix-forming material comprises a precursor liquid capable of forming a metal oxide.

18. The system of claim 1, wherein the mesoporous matrix-forming material comprises a precursor liquid capable of forming a metal nitride.

19. The system of claim 1, the plurality of process chambers further comprising a cure chamber configured to convert the matrix-forming material into a matrix.

20. The system of claim 19, further comprising means for removing the template material after the matrix-forming material is converted into a matrix.

21. The system of claim 20, wherein the means for removing comprises a plasma generator.

22. The system of claim 1, further comprising means for curing the mesoporous matrix forming material to form a mesoporous matrix, for removing the template-forming material from the matrix, and for dehydroxylating the mesoporous matrix to form a dehydroxylated matrix.

23. The system of claim 22, further comprising means for forming an oxide cap over the dehydroxylated matrix.

24. The system of claim 1, wherein the processing chambers comprise at least one cylindrical reactor including a male component and a female component.

25. The system of claim 1, wherein the controller is programmed to provide selected permutations of process functionalities for template formation, infusion, and detemplatating options using the plurality of process chambers.

26. A method of producing mesoporous materials on a substrate through use of a deposition system having a plurality of process chambers that include a template deposition chamber and a supercritical infusion chamber, the method comprising the steps of:
depositing a template on the substrate in the template deposition chamber; and
infusing the template with a mesoporous matrix through use of the supercritical infusion chamber.

27. The method of claim 26, wherein the step of depositing includes coating a wafer with a template-forming precursor solution.

28. The method of claim 27, further comprising a step of curing the template-forming precursor solution to form the template.

29. The method of claim 26, wherein the step of infusing comprises dissolving a matrix-forming precursor in a supercritical solvent to form a precursor-bearing solvent, and contacting the template with the precursor-bearing solvent.

30. The method of claim 26, further comprising a step of exposing the substrate to an electric field during at least one of the depositing and infusing steps.
